(19) United States
(12) Patent Application Publication
(10) Pub. No.: US 2016/0036871 A1
(43) Pub. Date: Feb. 4, 2016

(54) INFORMATION TRANSMISSION SYSTEM, COMMUNICATION TERMINAL, COMMUNICATION SYSTEM, AND INFORMATION TRANSMISSION METHOD

(71) Applicants: Shuhei TSUBONE, Tokyo (JP); Yoshinaga KATO, Kanagawa (JP)

(72) Inventors: Shuhei TSUBONE, Tokyo (JP); Yoshinaga KATO, Kanagawa (JP)

(21) Appl. No.: 14/794,267

(22) Filed: Jul. 8, 2015

(30) Foreign Application Priority Data
Jul. 30, 2014 (JP) 2014-154435
Apr. 14, 2015 (JP) 2015-082593

(51) Int. Cl. H04L 29/06

(52) U.S. Cl. CPC H04L 65/40; H04L 63/0869; H04L 63/083; H04L 65/1096

(57) ABSTRACT

An information transmission system receives, from a first communication terminal that requests for starting communication, user identification information for identifying a first user who is currently operating the first communication terminal, and transmits the user identification information of the first user to a second communication terminal, before establishing a session between the first communication terminal and the second communication terminal to start communication between the first communication terminal and the second communication terminal.

### CROSS-REFERENCE TO RELATED APPLICATIONS

This patent application is based on and claims priority pursuant to 35 U.S.C. §119(a) to Japanese Patent Application Nos. 2014-154435, filed on Jul. 30, 2014, and 2015-082593, filed on Apr. 14, 2015, in the Japan Patent Office, the entire disclosure of which is hereby incorporated by reference herein.

### BACKGROUND

1. Technical Field

The present invention generally relates to an information transmission system, a communication terminal, a communication system, and an information transmission method.

2. Description of the Related Art

With the increased need for reduction in business trip costs and time in recent years, communication systems that communicate via a communication network such as the Internet or a dedicated line are widely spread. In the communication systems, content data such as image data or sound data are transmitted or received among a plurality of communication terminals to carry out videoconference.

When requesting to start communication with a counterpart terminal, a terminal that requests to start communication may transmit a phone number or an account name of a caller to the counterpart terminal. With this information, a callee at the counterpart terminal is able to know beforehand who is calling.

### SUMMARY

Example embodiments of the present invention include an information transmission system, which receives, from a first communication terminal that requests for starting communication, user identification information for identifying a first user who is currently operating the first communication terminal, and transmits the user identification information of the first user to a second communication terminal, before establishing a session between the first communication terminal and the second communication terminal to start communication between the first communication terminal and the second communication terminal.

Example embodiments of the present invention include the first communication terminal, which obtains user identification information for identifying a first user who is currently operating the first communication terminal, from a printed document provided by the first user.

Example embodiments of the present invention include the second communication terminal, which includes a display provided for the second communication terminal and configured to display a screen including the user identification information of the first user, before the second communication terminal starts communicating with the first communication terminal.

Example embodiments of the present invention include a communication system including at least one of the first communication terminal, the second communication terminal, and the information transmission system, a method performed by any one of the first communication terminal, the second communication terminal, and the information transmission system, and a non-transitory recording medium storing a plurality of instructions which cause one or more processors to perform any one of the above-described methods.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a communication system according to an example embodiment of the present invention;

FIG. 2 is a perspective view illustrating a terminal of the communication system of FIG. 1;

FIG. 3 is a schematic block diagram illustrating a hardware configuration of the terminal of FIG. 2;

FIG. 4 is a schematic block diagram illustrating a hardware configuration of a management system, relay device, program providing system, or maintenance system of the communication system of FIG. 1;

FIG. 5 is a schematic block diagram illustrating a software configuration of the terminal of FIG. 1;

FIG. 6 is a schematic block diagram illustrating a functional configuration of the terminal and the management system of the communication system of FIG. 1;

FIG. 7A is an illustration of an example data structure of an authentication management table;

FIG. 7B is an illustration of an example data structure of a terminal management table;

FIGS. 8A and 8B (FIG. 8) are an illustration of an example data structure of a state change management table;

FIG. 8C is an illustration of an example data structure of a group data management table;

FIG. 8D is an illustration of an example data structure of a waiting data management table;

FIG. 9 is an illustration for explaining transition of a communication state of the terminal according to management data;

FIG. 10 is a data sequence diagram illustrating operation of processing an activation request;

FIG. 11 is a data sequence diagram illustrating operation of processing a request for starting communication with a counterpart terminal at a call center, according to an example embodiment of the present invention;

FIG. 12 is an illustration of an example reception screen;

FIG. 13 is a flowchart illustrating operation of transmitting notification to the waiting terminal, according to an example embodiment of the present invention;

FIG. 14 is an illustration of an example conference screen;

FIG. 15 is a schematic diagram illustrating a communication system according to an example embodiment of the present invention;

FIG. 16 is a schematic block diagram illustrating a hardware configuration of an image reading device of the communication system of FIG. 15;

FIG. 17 is a schematic block diagram illustrating a functional configuration of the management system and the image reading device of the communication system of FIG. 15:

FIG. 18 is an illustration of an example data structure of a guest management table;

FIG. 19 is an illustration for explaining transmission or reception of content data and various management data;

FIG. 20 is a data sequence diagram illustrating operation of processing a request for starting communication with a counterpart terminal at a call center, according to an example embodiment of the present invention;

FIG. 21 is an example reception screen;

FIG. 22 is a flowchart illustrating operation of managing information regarding the guest;

FIG. 23 is a flowchart illustrating operation of transmitting notification to the waiting terminal;

FIG. 24 is an illustration of an example conference screen; and

FIG. 25 is an illustration of an example screen for entering supplementary data.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Referring now to the drawings, an embodiment of the present invention is described. In the following, a “communication terminal” may simply be referred to as a “terminal”, and a “communication management system” may simply be referred to as a “management system”.

<Configuration of Communication System>

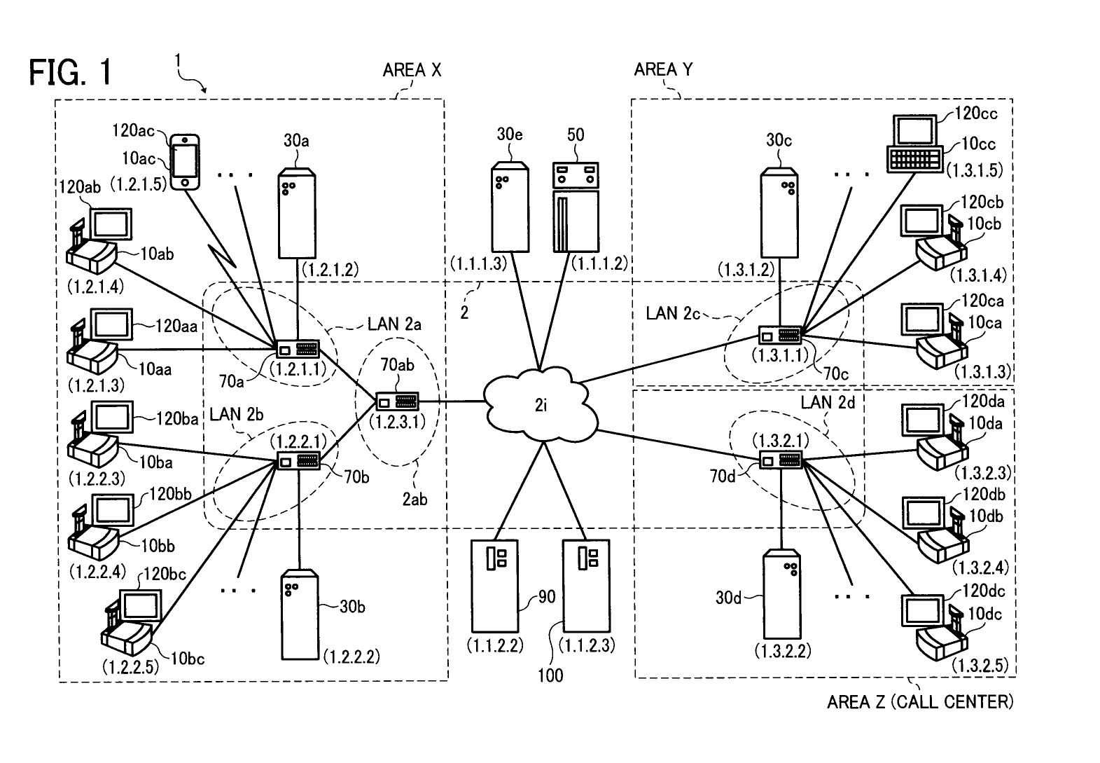

FIG. 1 is a schematic diagram illustrating a configuration of a communication system according to an example embodiment of the present invention. As illustrated in FIG. 1, the communication system 1 includes a plurality of terminals (10aa, 10ab, . . . ), a plurality of displays (120aa, 120ab, . . . ) for respective terminals (10aa, 10ab, . . . ), a plurality of relay devices (30a, 30b, 30c, 30d, 30e), a management system 50, a program providing system 90, and a maintenance system 100. The communication system 1 controls communication of content data, such as image data and sound data, to carry out videoconference among a plurality of remotely located sites. One or more of a plurality of routers (70a, 70b, 70c, 70d, 70ad) is selected to relay content data via an optical route.

The terminals (10aa, 10ab, 10ac, . . . ), the relay device 30a, and the router 70a are connected through a LAN 2a to be communicable with each other. The LAN 2a and the LAN 2b are connected through a dedicated line 2ab including the router 70ab to be communicable with each other. The LAN 2a, the LAN 2b, and the dedicated line 2ab are provided in an area X. Any one of these devices may be connected directly to the Internet 2i, without using the dedicated line.

The terminals (10ca, 10cb, 10c, . . . ), the relay device 30c, and the router 70c are connected through the LAN 2c to be communicable with each other through the LAN 2c. The LAN 2c is provided in an area Y.

The terminals (10da, 10db, 10dc, . . . ), the relay device 30d, and the router 70d are connected through the LAN 2d to be communicable with each other. The LAN 2d is provided in an area Z. The areas X, Y, and Z may be located within one country, or over different countries.

The areas X, Y, and Z are connected through the routers (70ab, 70c, and 70d) to the Internet 2i to be communicable. In this example, the area Z is a location where a call center is provided. In this disclosure, any one of the terminals 10 (10da, 10db, 10dc, . . . ) located at the call center may be referred to as the call center terminal 10d. As described below, the terminal 10 connects with at least one terminal 10d (10da, 10db, 10dc, . . . ) at the call center to have reception services.

In the following, any arbitrary terminal of the plurality of terminals (10aa, 10ab, . . . ) is referred to as the terminal 10. Any arbitrary display of the plurality of displays (120aa, 120ab, . . . ) is referred to as the display 120. Any arbitrary relay device of the relay devices (30a, 30b, 30c, 30d, 30e) is referred to as the relay device 30. Any arbitrary router of the plurality of routers (70a, 70b, 70c, 70d, 70ab) is referred to as the router 70.

The management system 50, the program providing system 90, and the maintenance system 100 are connected to the Internet 2i. The management system 50, the program providing system 90, and the maintenance system 100 may be provided in any of the areas X, Y, and Z, or any area other than the areas X, Y, and Z.

In this example, the communication network 2 includes the LAN (2a, 2b, 2c, 2d), the dedicated line 2ab, and the Internet 2i. The communication network 2 may not only include a wired network, but also a wireless network such as a network in compliance with WiFi (Wireless Fidelity) or Bluetooth, or a mobile phone network.

In FIG. 1, four digits shown below each one of the terminals 10, the relay devices 30, the management system 50, the routers 70, the program providing system 90, and the maintenance system 100 indicate a simplified expression of IP address that is assigned to each device capable of functioning as a communication device. For simplicity, the IP address is expressed in Internet Protocol version 4 (IPv4), but the IP address may be expressed in IPv6 instead.

When application is executed, the terminals 10 transmit or receive content data such as image data and sound data, to carry out communication among the users. More specifically, the terminal 10 transmits or receives content data using a predetermined communications protocol. The communications protocol used by the terminal 10 is mainly defined by a call control protocol used for connecting or disconnecting connections with the counterpart terminal, and an encoding format used for encoding the contents data to an IP packet.

Examples of the call control protocol being used by the terminal 10 include, but not limited to, (1) session initial protocol (SIP), (2) H.323, (3) the extended SIP, (4) Instant Messenger (IM) Protocol such as extensible messaging and presence protocol (XMPP), ICQ (Registered Trademark), AIM (Registered Trademark), or Skype (Registered Trademark), (5) protocol using the SIP message method, (6) Internet relay chat (IRC) protocol, and (7) extended IM based protocol such as Jingle.

<Hardware Configuration>

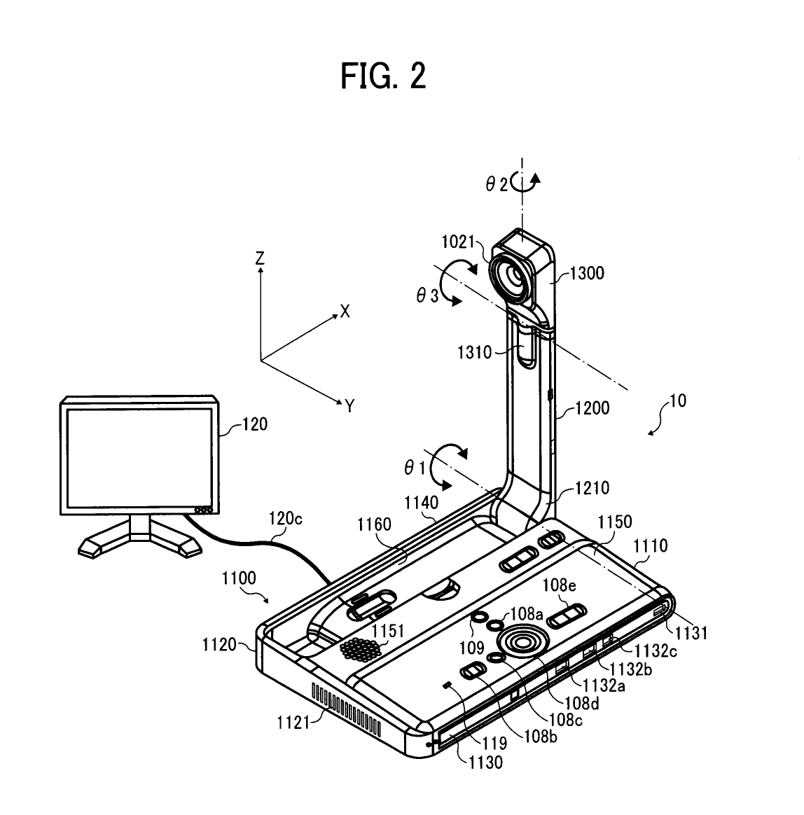

Now, a hardware configuration of the communication system 1 is explained. FIG. 2 is a perspective view illustrating the terminal 10 according to an example embodiment of the present invention. The terminal 10 includes a casing 1100, an arm 120, and a camera housing 1300. The casing 1100 includes a front side wall 1100 having a plurality of air intake holes formed over the nearly entire surface of the intake surface, and a back side wall 1120 having a plurality of exhaust holes over the nearly entire surface of the exhaust surface 1121. When a cooling fan in the casing 1100 is driven, air flows in through the intake holes of the intake surface and out through the exhaust holes of the exhaust surface 1121. The casing 1100 further includes a right side wall 1130 formed with a sound pickup hole 1131. Through the sound pickup hole 1131, a microphone 114 of the terminal 10 is able to catch sounds such as human voice or any sound including noise.

The casing 1100 has an operation panel 1150, which is provided at a front surface toward the right side wall 1130. The operation panel 1150 includes a plurality of operation keys 108a to 108e, a power switch 109, an alarm lamp 119, and a plurality of sound output holes 1151. Through the sound output holes 1151, a speaker 115 of the terminal 10 is able to output sounds such as sounds generated based on human voice. The casing 1100 further includes a holder 1160, which is provided at the front surface toward the left side wall 1140.

The holder 1160, which has a concave shape, accommodates therein the arm 1200 and the camera housing 1300. The right side wall 1130 is further provided with a plurality of connection ports 1132a to 1132c (“connection ports 1132”). The connection ports 1132 allow electrical connection to an external device through an external device connection I/F 118. The casing 1100 further includes a left side wall 1140, which is provided with a connection port to connect the external display 120 to the display I/F 117 through a cable 120c.

The following description uses the term “operation key(s) 108” for indicating an arbitrary one or ones of the operation keys (108a to 108e), and the term “connection port(s) 1132” for indicating an arbitrary one or ones of the connection ports (1132a to 1132c).

The arm 1200 is attached to the casing 1100 via a torque hinge 1210. With the torque hinge 1210, the arm 1200 can be rotated in directions of up and down with respect to the casing 1100, while making a tilt angle θ1 of up to 135 degrees. FIG. 2 illustrates the case where the tilt angle θ1 is 90 degrees.

The camera housing 1300 incorporates therein the camera 112 that takes an image of an object. The object may be a part of a user, document, or a room where the terminal 10 is located. The camera housing 1300 is provided with a torque hinge 1310. The camera housing 1300 is attached to the arm 1200 through the torque hinge 1310. With the torque hinge 1310, the camera housing 1300 can be rotated with respect to the arm 1200, in the direction of up, down, right, and left, such that the camera housing 1300 is kept at a desired position. More specifically, the camera housing 1300 can be rotated, while making a pan angle θ2 from about −180 degrees to 180 degrees in the direction right and left, and a tilt angle θ3 that ranges from about −45 degrees to +45 degrees in the direction of up and down. In FIG. 2, the pan angle θ2 and the tilt angle θ3 are each 0 degree.

Note that the external view illustrated in FIG. 2 is only exemplary and the appearance is not restricted thereto. The communication terminal 10 may be, for example, a general-purpose personal computer (PC), a portable phone, a projector, an electronic whiteboard, or a digital signage (See 10ac and 10cc in FIG. 1). When the terminal 10, for example, when implemented by a computer, is not provided with a microphone or a camera, any external microphone or external camera may be connected with the terminal 10. When the terminal 10 is implemented by the PC or the portable phone, the terminal 10 is connected to the Internet 2i through a wireless network such as a wireless LAN or mobile phone network. Further, when the terminal 10 is implemented by PC, such PC may be previously installed with application for enabling the PC to function as the videoconference terminal 10 of FIG. 2 as described below.

Since the communication management system 50, the program providing system 90, and the maintenance system 100 has the same appearance as that of a general server computer, a description of the appearance thereof is omitted.

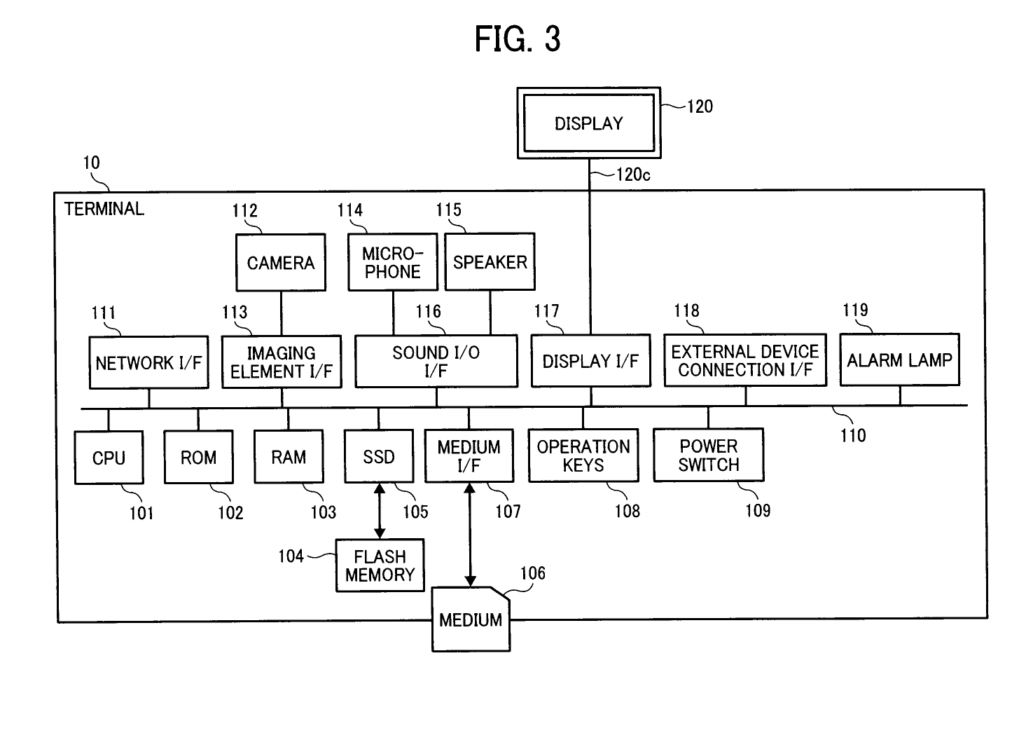

FIG. 3 illustrates a hardware configuration of the terminal 10 according to the embodiment of the present invention. The terminal 10 includes a central processing unit (CPU) 101 that controls entire operation of the terminal 10, a read-only memory (ROM) 102 that stores a program used for driving the CPU 101, such as an initial program loader (IPL), a random-access memory (RAM) 103 used as a work area for the CPU 101, a flash memory 104 that stores various types of data, such as the terminal control program, image data, and sound data, a solid state drive (SSD) 105 that controls reading/writing of various types of data from/to the flash memory 104 under control of the CPU 101, a medium I/F 107 (such as a medium drive) that controls reading/writing (storage) of data from/to a recording medium 106 such as a flash memory or an IC card, the operation keys 108 operated in the case of, for example, selecting a counterpart terminal of the terminal 10, the power switch 109 for turning on/off the power of the terminal 10, and a network interface (I/F) 111 for transmitting data using the communication network 2.

The terminal 10 further includes the built-in camera 112 that captures an image of a subject and obtains image data under control of the CPU 101, an imaging element OF 113 that controls driving of the camera 112, the built-in microphone 114 that receives a sound input, the built-in speaker 115 that outputs sounds, a sound input/output I/F 116 that processes inputting/outputting of a sound signal between the microphone 114 and the speaker 115 under control of the CPU 101, a display I/F 117 that transmits image data to an external display 120 under control of the CPU 101, the external device connection I/F 118 for connecting various external devices, an alarm lamp 119 that alarms an error in function of the terminal 10, and a bus line 110 such as an address bus and a data bus for electrically connecting the above-described elements as illustrated in FIG. 3.

The display 120 is a display formed of liquid crystal or organic electroluminescence (EL) that displays an image of a subject, an operation icon, or the like. The display 120 is connected to the display I/F 117 by the cable 120c. The cable 120c may be an analog red green blue (RGB) (video graphic array (VGA)) signal cable, a component video cable, a high-definition multimedia interface (HDMI) signal cable, or a digital video interactive (DVI) signal cable.

The camera 112 includes a lens and a solid-state imaging element that converts an image (video) of a subject to electronic data through photoelectric conversion. As the solid-state imaging element, for example, a complementary metal-oxide-semiconductor (CMOS) or a charge-coupled device (CCD) is used.

The external device connection I/F 118 is capable of connecting an external device such as an external camera, an external microphone, or an external speaker by using a Universal Serial Bus (USB) cable that is inserted into the connection port 1132 or the like. In the case where an external camera is connected, the external camera is driven in preference to the built-in camera 112 under control of the CPU 101. Similarly, in the case where an external microphone is connected or an external speaker is connected, the external microphone or the external speaker is driven in preference to the built-in microphone 114 or the built-in speaker 115 under control of the CPU 101.

The recording medium 106 is removable from the terminal 10. The recording medium 106 can be any non-volatile memory that reads or writes data under control of the CPU 101, such that any memory such as an electrically erasable and programmable read-only memory (EEPROM) may be used instead of the flash memory 104.

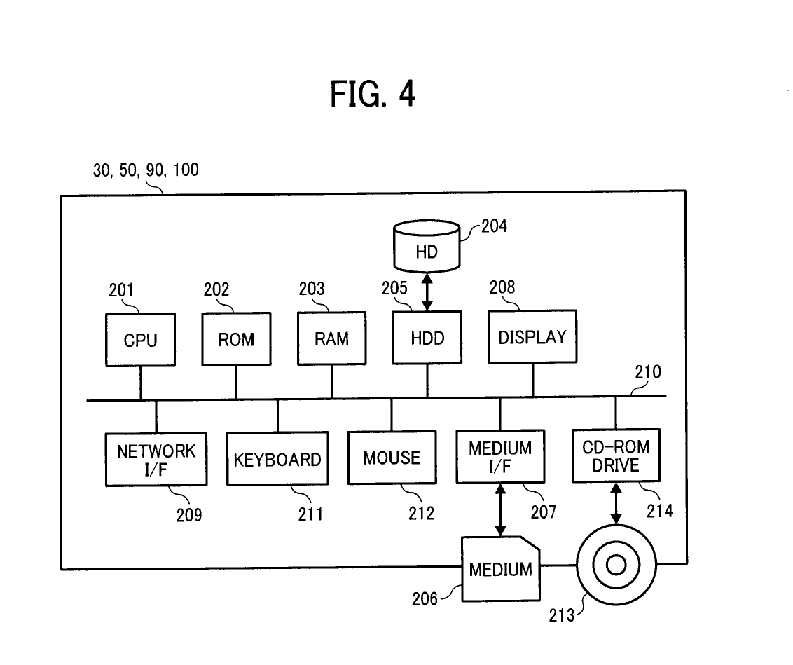

FIG. 4 illustrates a hardware configuration of the management system 50 according to the embodiment. The management system 50 includes a CPU 201 that controls entire operation of the management system 50, a ROM 202 that stores a program used for driving the CPU 201 such as an IPL, a RAM 203 used as a work area for the CPU 201, the HD 204 that stores various types of data such as the transmission management program, a hard disk drive (HDD) 205 that controls reading/writing of various types of data from/to the HD 204 under control of the CPU 201, a medium I/F 207 (such as a medium drive) that controls reading/writing (storage) of data from/to a recording medium 206 such as a flash memory, a display 208 that displays various types of information such as a cursor, a menu, a window, characters, or an image, a network I/F 209 for transmitting data using the communication network 2, a keyboard 211 including a plurality of keys for entering characters, numerals, and various instructions, a mouse 212 that selects and executes various instructions such as selection of a processing target or movement of the cursor, a compact disc read-only memory (CD-ROM) drive 214 that controls reading/writing of various types of data from/to a CD-ROM 213 serving as an example of a removable recording medium, and a bus line 210 such as an address bus and a data bus for electrically connecting the above-described elements.

Since the relay devices 30, the program providing system 90, and the maintenance system 100 each have a hardware configuration that is the same as or similar to that of the above-described management system 50, a description thereof is omitted.

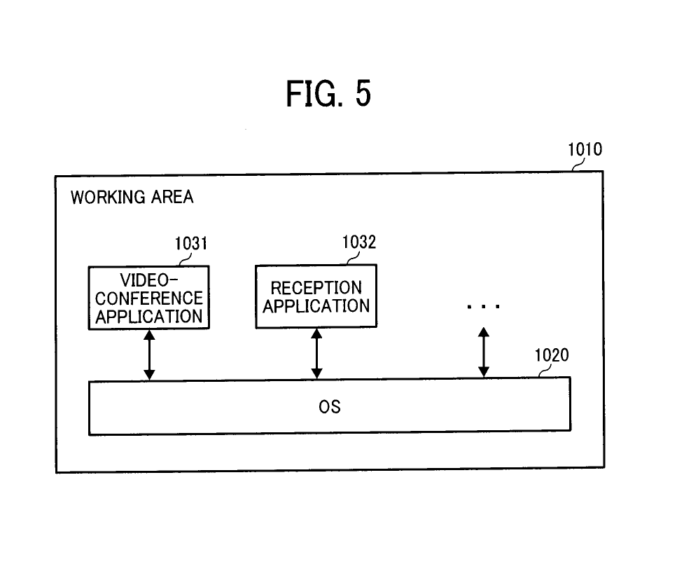

FIG. 5 illustrates a software configuration of the terminal 10 according to the embodiment of the present invention. As illustrated in FIG. 5, the terminal 10 is installed with an OS 1020, videoconference application 1031, and reception application 1032, each of which operates on a work area 1010 of the RAM 103.

The OS 1020 is basic software that controls entire operation of the terminal 10 through providing basic functions. The videoconference application 1031 enables the terminal 10 to communicate with the other terminal 10 to carry out videoconference. The reception application 1032 enables the terminal 10 to communicate with the terminal 10d at the call center to have conversation (communication) with the operator at the call center.

In alternative to the above-described application, any other application may be installed on the terminal 10. For example, the program providing system 90 may store any desired application in its memory, and upon request from the terminal 10, transfer such application to be downloaded onto the terminal 10. Further, a plurality of types of videoconference application 1031 may be installed, such as application that differs in communications protocol.

### <Functional Configuration of Communication System>

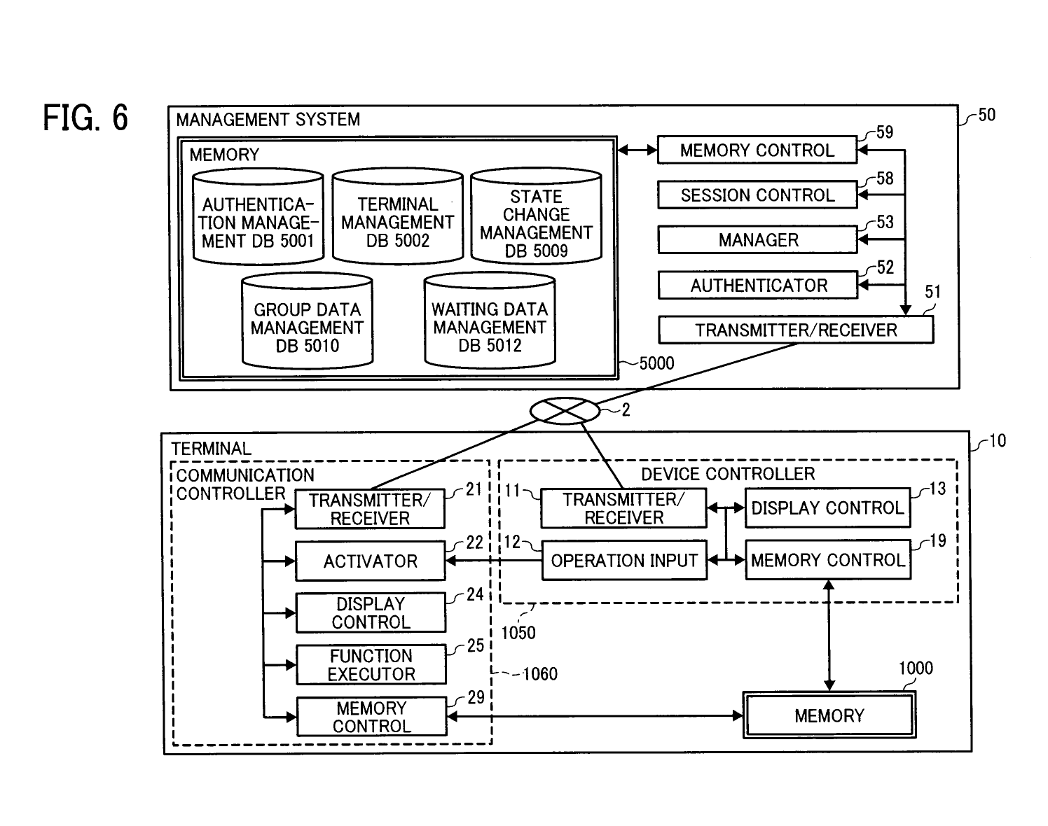

Now, functional configuration of the communication system 1 is explained. FIG. 6 is a schematic block diagram illustrating a functional configuration of the terminal 10 and the management system 50 in the communication system 1. In FIG. 6, the terminal 10 and the management system 50 are connected through the Internet 2 to transmit or receive data.

### <Functional Configuration of Terminal>

The terminal 10 includes a device controller 1050 and a communication controller 1060. The device controller 1050 is implemented with execution of the OS 1020. The communication controller 1060 is implemented with execution of the videoconference application 1031 or the reception application 1032.

The device controller 1050 includes a transmitter/receiver 11, an operation input 12, a display control 13, and a memory control 19. These elements in FIG. 6 correspond to a plurality of functions, which are executed according to the instructions of the CPU 101 (FIG. 3) that are generated according to application (such as the OS 1020) being loaded from the flash memory 104 onto the RAM 103.

The communication controller 1060 includes a transmitter/receiver 21, an activator 22, a display control 24, a function executor 25, and a memory control 29. These elements shown in FIG. 6 correspond to a plurality of functions, which are performed by the elements shown in FIG. 3 according to the instructions of the CPU 101 (FIG. 3) that are generated according to the videoconference application 1031 or the reception application 1032 being loaded from the flash memory 104 onto the RAM 103.

The terminal 10 further includes a memory 1000, which is implemented by the ROM 102, RAM 103, or flash memory 104 of FIG. 3.

### (Functional Configuration of Device Controller)

Now, functional configuration of the device controller 1050 of the terminal 10 is explained according to an example embodiment of the present invention. In the following description of functional configuration of the device controller 1050 of the terminal 10, relationships with main elements for implementing the functional configuration of the device controller 1050 shown in FIG. 2 is also described.

The transmitter/receiver 11, which is implemented by instructions of the CPU 101 and the network I/F 111, transmits or receives various data (or information) to or from the counterpart terminal, each device or system, through the communication network 2.

The operation input 12, which may be implemented by instructions of the CPU 101, the operation keys (108a, 108b, 108c, 108d, 108e), and the power switch 109, receives various inputs or selections from the user.

The display control 13, which may be implemented by the instructions of the CPU 101 and the display I/F 117, controls display of an image through the display 120.

The memory control 19, which may be implemented by the instructions of the CPU 101 and the SSD 105, or the instructions of the CPU 101, stores various data in the memory 1000 or reads various data from the memory 1000.

### (Functional Configuration of Communication Controller)

Next, functional configuration of the communication controller 1060 of the terminal 10 is explained according to the embodiment of the present invention. In the following description of functional configuration of the communication controller 1060 of the terminal 10, relationships with hardware elements for implementing the functional configuration of the communication controller 1060 is also described.

The transmitter/receiver 21, which may be implemented by the instructions of the CPU 101 and the network I/F 111, transmits or receives various data (or information) to or from the counterpart terminal, each device or system, through the communication network 2.

The activator 22, which may be implemented by instructions of the CPU 101, activates the communication controller 1060, in response to an activation request at the operation input 12, when the operation input 12 receives a user selection of application. More specifically, when the user selects activation of the videoconference application 1031, the communication controller 1060 is activated under control of the videoconference application 1031. When the user selects activation of the reception application 1032, the communication controller 1060 is activated under control of the reception application 1032.

The display control 24, which may be implemented by the instructions of the CPU 101 and the display I/F 117, controls transmission of image data to the display 120. Further, the display control 24 controls a user interface for display to the user, according to the selected application such as the videoconference application 1031 or the reception application 1032. The display control 24 is able to control display of information in a manner that matches the user's current needs according to the selected application.

The functional executor 25, which may be implemented by the instructions of the CPU 101, and at least one of the camera 112, microphone 114, and speaker 115, controls communication of image data or sound data.

The memory control 29, which may be implemented by the instructions of the CPU 101 and the SSD 105, or the instructions of the CPU 101, stores various data in the memory 1000 or reads various data from the memory 1000.

### <Functional Configuration of Management System>

Referring to FIG. 6, the management system 50 includes a transmitter/receiver 51, an authenticator 52, a manager 53, a session controller 58, and a memory control 59. These elements correspond to a plurality of functions of hardware elements in FIG. 4, which operate according to the instructions of the CPU 101 (FIG. 4) that are generated according to the management system program read from the RAM 203 onto the HD 204. The management system 50 further includes a memory 5000, which may be implemented by the HD 204. The memory 5000 stores, for each application being managed by the management system 50, application ID and application icon data. The memory 5000 further stores a plurality of databases (DBs) as described below.

(Authentication Management Table)

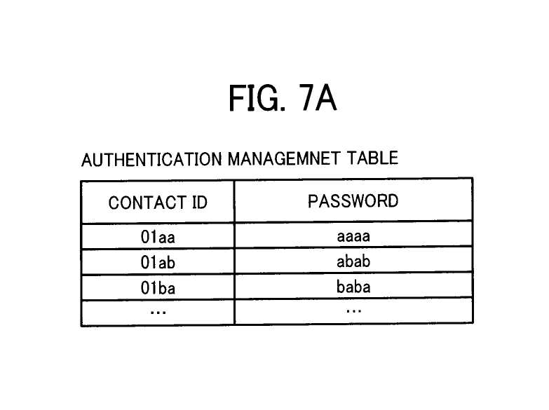

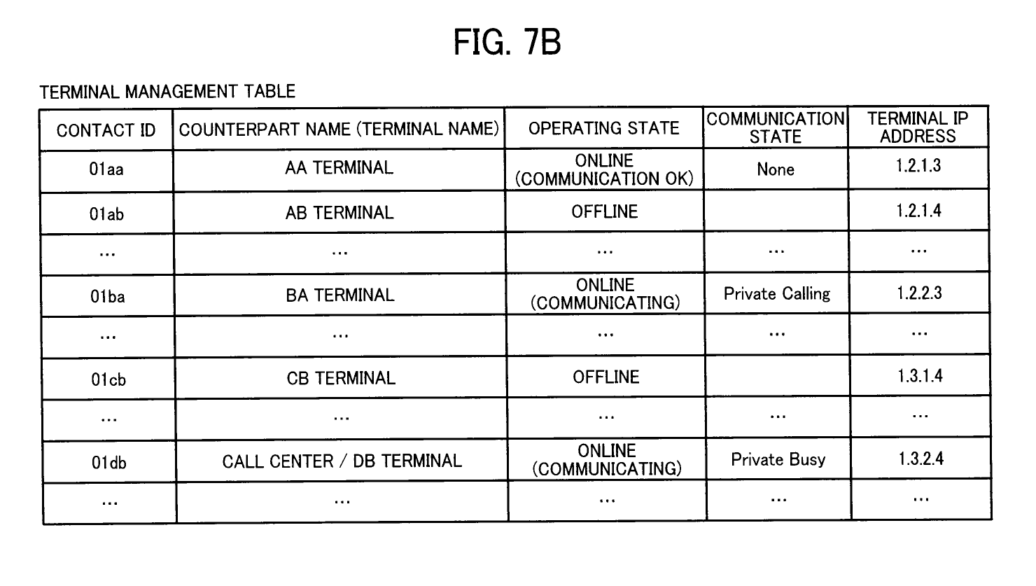

FIG. 7A is a conceptual diagram illustrating an authentication management table. The memory 5000 stores an authentication management DB 5001, which may be implemented by the authentication management table of FIG. 7A. The authentication management table of FIG. 7A stores, for each one of a plurality of terminals 10 that are managed by the management system 50, a contact ID and a password to be used for authentication. The contact ID is any information for identifying a communication destination in the communication system 1. Examples of contact ID include, but not limited to, terminal identification information for identifying the terminal 10 such as the terminal ID, identification information for identifying a user of the terminal 10 such as a user account, and group identification information for identifying a group to which the terminal 10 belongs. In the following, it is assumed that the terminal identification information or the group identification information is used as the contact ID of the terminal 10.

(Terminal Management Table)

FIG. 7B is a conceptual diagram illustrating a terminal management table. The memory 5000 stores a terminal management DB 5002, which may be implemented by the terminal management table of FIG. 7B. The terminal management table of FIG. 7B stores, for each one of the plurality of terminals 10 managed by the management system 50, the contact ID of the terminal 10, the counterpart name (terminal name) of the terminal 10 when serving as a communication destination of the other terminal, the operating state of the terminal 10, the communication state of the terminal 10, and an IP address assigned to the terminal 10, in association with one another. The communication state of the terminal 10 indicates the current state of the terminal 10 in communicating with the other terminal 10. For example, the communication state of the terminal 10 indicates whether the terminal 10 is ready for communication, busy, etc.

(State Change Management Table)

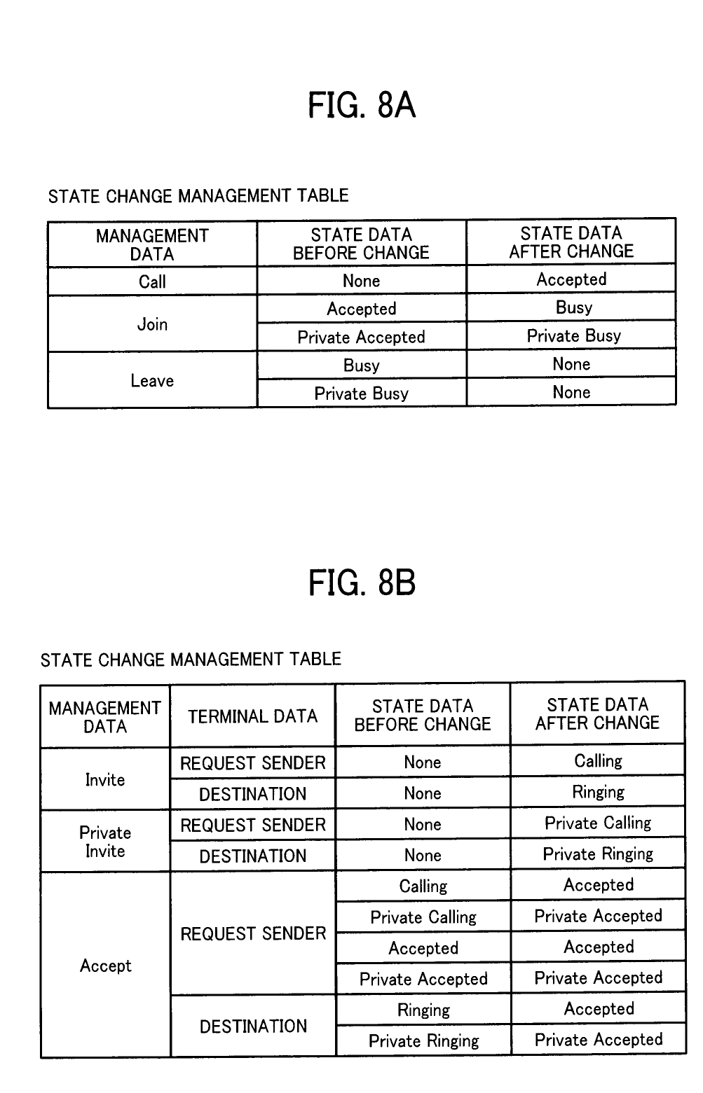

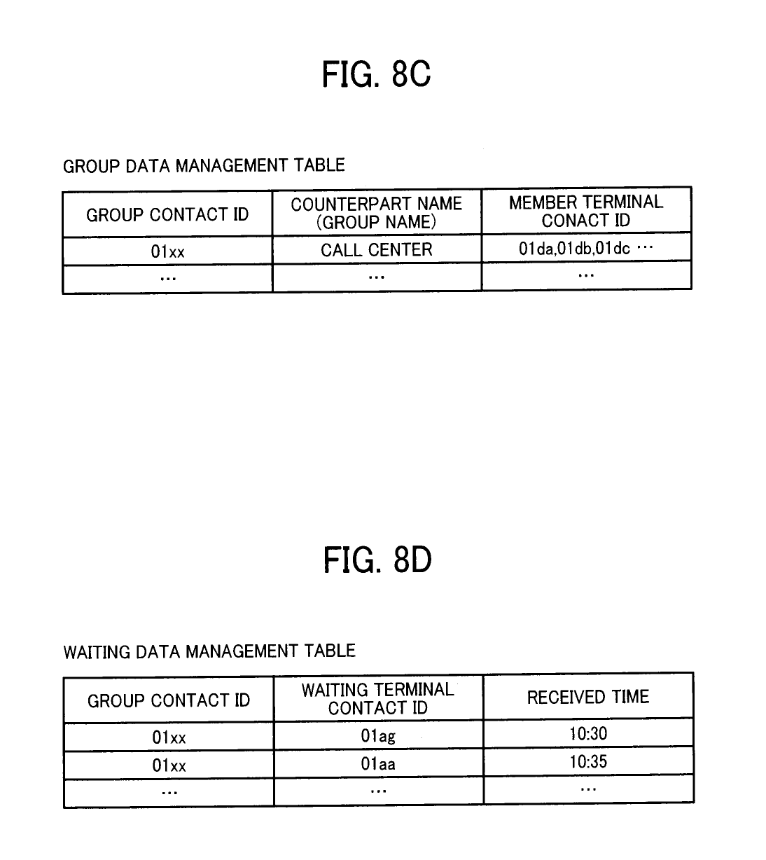

FIG. 8A and FIG. 8B (FIG. 8) illustrate examples of a state change management table. The memory 5000 stores a state change management DB 5009, which may be implemented by the state change management table of FIG. 8A and FIG. 8B. The state change management table of FIG. 8 stores management data to be used for controlling a session between the terminals 10, which indicates a type of action relating to the session. More specifically, the management data “Invite” is management data, which is to be transmitted to the management system 50 with a request for starting communication with a counterpart terminal. The “Private Invite” is used when participation from the other terminals is restricted. The management data “Join” is management data, which is to be transmitted to the management system 50 with a request for starting relay of content data. The management data “Leave” is management data, which is to be transmitted to the management system 50 with a request for ending the session. The management data “Accept” is management data, which is to be transmitted to the management system 50 with a response indicating acceptance of the communication start request. The management data “Call” is management data, which is to be transmitted to the management system 50 with a request for participating in the established session.

The management data “Call”, “Join”, and “Leave” are stored in the state change management table of FIG. 8A, as transition of the state data is the same between the request sender terminal and the request destination terminal. The management data “Invite”, “Private Invite”, and “Accept” are stored in the state change management table of FIG. 8B, as transition of the state data differs between the request sender terminal and the request destination terminal.

The state change management table of FIG. 8A stores, for each management data, pre-change state data (“state data before change”) indicating a communication state of the terminal before the management data is received, and post-change state data (“state data after change”) indicating a communication state of the terminal after the management data is received, in association with one another.

The state change management table of FIG. 8B stores the management data, terminal data indicating whether the terminal 10 is a request sender terminal or a request destination terminal, the pre-change state data, and the post-change state data, in association with one another.

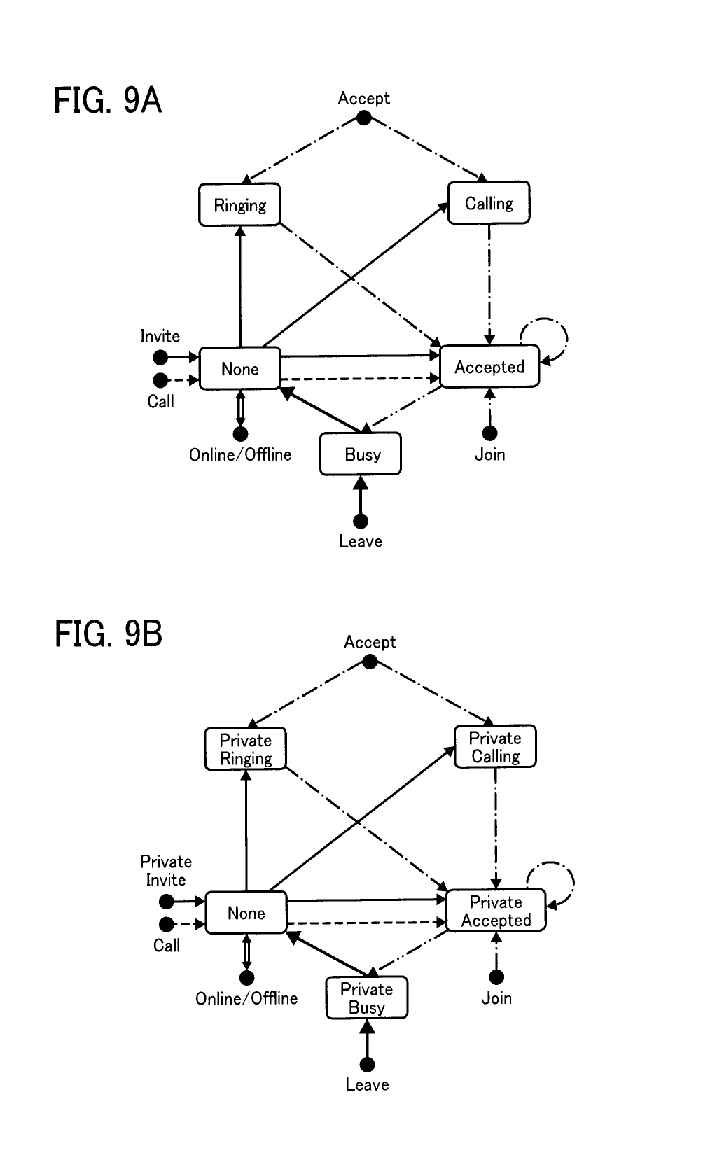

FIG. 9A and FIG. 9B illustrate transition of the communication state of the terminal 10 according to state change rules that are respectively defined with the state change management tables of FIGS. 8A and 8B. For example, it is assumed that the request sender terminal 10 sends an instruction in the form of management data “Private Invite” to the management system 50. In such case, based on the management data “Private Invite”, the manager 53 of the management system 50 changes the communication state of the request sender terminal 10 from “None” to “Private Calling”, as illustrated in FIG. 9B. Alternatively, the state change management tables of FIGS. 8A and 8B may be integrated into one table.

(Group Data Management Table)

FIG. 8C is a conceptual diagram illustrating a group data management table. The memory 5000 stores a group data management DB 5010, which may be implemented by the group data management table of FIG. 8C. The group data management table of FIG. 8C stores, for each group of terminals being managed by the management system 50, a group contact ID for identifying the group, a counterpart name (group name) of the group of terminals when serving as a communication destination, and contact IDs of the terminals 10 belonging to that group, in association with one another. Each one or more of the terminals 10 belonging to the group may be referred to as the member terminal 10. In this example illustrated in FIG. 8C, information regarding the group of terminals 10d at the call center is stored.

(Waiting Data Management Table)

FIG. 8D is a conceptual diagram illustrating a waiting data management table. The memory 5000 stores a waiting data management DB 5012, which may be implemented by the waiting data management table of FIG. 8D. The waiting data management table of FIG. 8D stores, for each one of terminals 10 that are waiting to start communication with the other terminal, the group contact ID of the terminal 10 that the waiting terminal 10 requests to start communciation, the contact ID of the waiting terminal 10 that is waiting to start communication with the terminal 10 belonging to that group, and the received date/time at which the management system 50 receives a communication start request for starting communication between the waiting terminal 10 and the terminal 10 in that group. More specifically, in this example, the waiting data management table of FIG. 8D stores one or more waiting terminals 10 that are waiting to start communication with any terminal 10d at the call center.

<Functional Configuration of Management System>

Now, functional configuration of the management system 50 is explained according to an example embodiment of the present invention. In the following description of functional configuration of the management system 50 in FIG. 6, the relationships with hardware elements for implementing the functional configuration of the management system 50 in FIG. 4 is also described.

The transmitter/receiver 51, which may be implemented by the instructions of the CPU 201 and the network I/F 209, transmits or receives various data (or information) to or from each terminal, device, or system through the communication network 2.

The authenticator 52, which may be implemented by the instructions of the CPU 201, searches the authentication management table (FIG. 7A) using a contact ID and a password received at the transmitter/receiver 51 as a search key, to authenticate the terminal 10 based on determination of whether the same contact ID and password are managed in the authentication management table.

The manager 53, which may be implemented by the instructions of the CPU 201, updates the operating state, communication state, etc., in the terminal management table of FIG. 7B to keep updated such as the operating state and the communication state in the terminal management table of FIG. 7B.

The session controller 58, which may be implemented by the instructions of the CPU 201, controls a session through which content data is transmitted between the terminals 10. Examples of control include, but not limited to, control to establish a session, control to enable the terminal 10 to participate in the established session, and control to end the session.

The memory control 59, which may be implemented by the instructions of the CPU 201 and the HDD 205, or the instructions of the CPU 201, stores various data in the memory 5000 or reads various data from the memory 5000.

<Operation of Communication System>

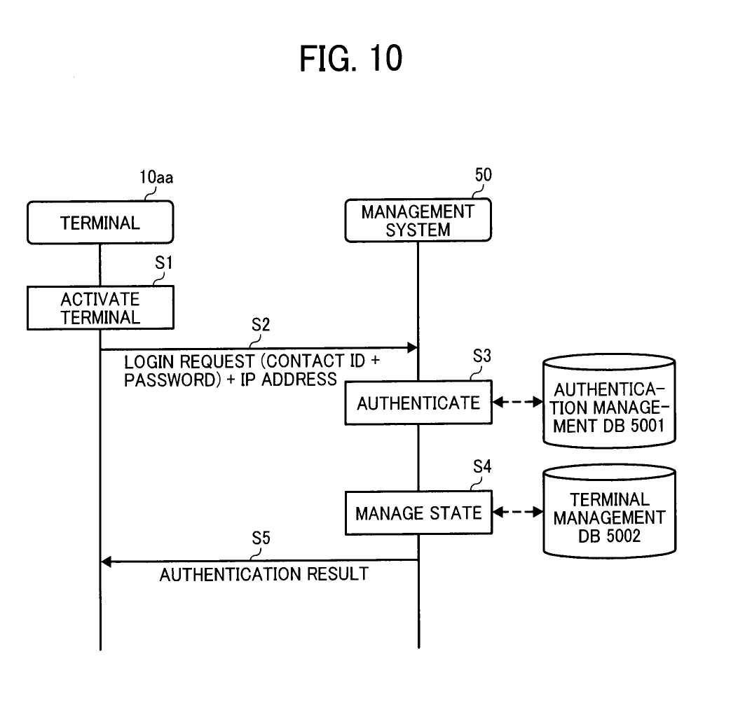

Now, operation performed by the communication system 1 is explained according to an example embodiment of the present invention. Referring to FIG. 10, operation from the time when the terminal 10aa is activated, to the time when the terminal 10aa logs into the communication system 1, is explained. FIG. 10 is a data sequence diagram illustrating operation performed by the communication system 1, from the time when the terminal 10 is activated to the time when the terminal 10aa logs in.

In response to turning on of the power switch 109 by the user, at S1, the operation input 12 accepts the instruction for turning on, and the terminal 10aa is turned on to be activated. In response to receiving turning on operation, at S2, the transmitter/receiver 11 sends a login request to the management system 50 through the communication network 2. The management system 50 receives the login request at the transmitter/receiver 51. The login request includes a contact ID for identifying the terminal 10aa that sends the login request, and a password. These contact ID and password are read from the memory 1000 by the memory control 29, and transmitted to the transmitter/receiver 11. Alternatively, the contact ID and password may be input by the user through the operation key 108. As the terminal 10aa sends the login request to the management system 50, the management system 50, which is the receiver side, obtains the IP address of the terminal 10aa that is the sender side.

At S3, the authenticator 52 of the management system 50 searches the authentication management table of FIG. 7A using the contact ID and password included in the login request as a search key to authenticate the terminal 10aa based on determination of whether the same contact ID and password are managed in the authentication management table (FIG. 7A).

When the authenticator 52 determines that the terminal 10 that sends the login request is an authenticated terminal, at S4, the manager 53 stores, in the terminal management table of FIG. 7B, the contact ID “01aa” of the terminal 10aa, the operating state (“Online, communication OK”), the communication state “None”, and the IP address of the terminal 10aa in association with one another.

At S5, the transmitter/receiver 51 of the management system 50 transmits authentication result information indicating an authentication result, obtained by the authenticator 52, to the terminal 10aa that sends the login request through the communication network 2. The terminal 10aa receives the authentication result at the transmitter/receiver 11.

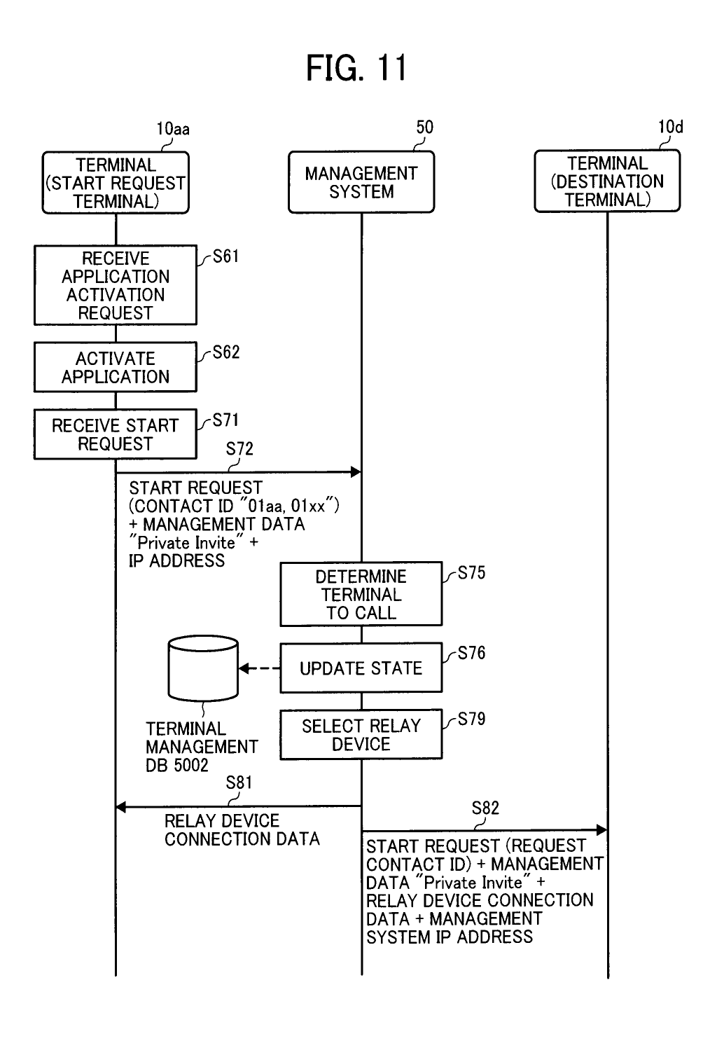

Referring now to FIG. 11, operation of activating the reception application 1032 at the terminal 10aa is explained according to an example embodiment of the present invention. FIG. 11 is a data sequence diagram illustrating operation of processing a request to start communication with a counterpart terminal 10, which is sent from the terminal 10aa. As described below, the communication start request of the terminal 10aa requests to have communication with the call center.

In response to receiving user operation onto the operation key 108 (108a to 108e) at the terminal 10aa, at S61, the operation input 12 of the terminal 10aa receives an activation request for activating the reception application 1032.

At S62, the operation input 12 of the device controller 1050 instructs the activator 22 to activate the communication controller 1060 according to the reception application 1032. While the above-described steps up to S62 is performed by the device controller 1050, the following steps after S62 is performed by the communication controller 1060 that is activated under control of the reception application 1032.

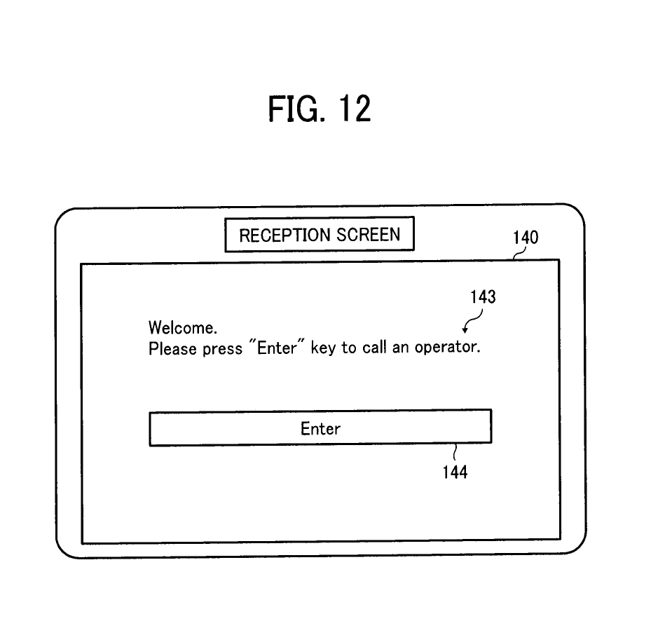

The display control 24 of the communication controller 1060 instructs the display 120aa to display a reception screen for accepting a request for starting communication with the terminal 10d at the call center. FIG. 12 is an example reception screen with a reception window 140. The reception screen of FIG. 12 includes, within the window 140, a message 143 that requests a user to start communication with the terminal 10d at the call center, and an “Enter” key 144 that receives a user instruction for requesting to start communication (that is, calling the operator at the call center). More specifically, the reception application 1032 controls the display control 24 to display a user interface specific to reception services.

In response to a user selection for selecting the key 144 on the reception screen of FIG. 12, at S71, the function executor 25 receives a communication start request for starting communication. At S72, the transmitter/receiver 11 of the terminal 10aa transmits a communication start request to the management system 50 with the IP address of the terminal 10aa. The communication start request includes the contact ID “01aa” of the terminal 10aa that sends the start request (request sender terminal), the contact ID “01xx” of a counterpart terminal, and the management data “Private Invite”. In this embodiment, the contact ID “01xx” of the counterpart terminal is a group contact ID for identifying the group of terminals 10d at the call center, which is automatically selected by the transmitter/receiver 21 under control of the reception application 1032. The management data “Private Invite” indicates a request for starting communication with the counterpart terminal while restricting participation from the other terminals. The management data “Private Invite” is automatically selected by the transmitter/receiver 21, under control of the reception application 1032. The reception application 1032 controls the transmitter/receiver 21 to automatically select the call center as a communication destination, and a type of session to be established. In this manner, the user at the terminal 10aa does not have to input further information to call the operator.

At S75, the session control 58 of the management system 50 refers to the terminal management table of FIG. 7B to select at least one terminal 10d having the operating state “Online (communication OK)”, from the group of terminals 10d belonging to the group identified by the group ID “01xx” in the group data management table of FIG. 8C. The session control 58 determines the selected terminal 10d as a counterpart terminal of the terminal 10aa, which is the terminal 10 that the terminal 10aa will call. For simplicity, such terminal 10d is referred to as the destination terminal 10d.

At S76, the manager 53 refers to the terminal management table of FIG. 7B to change the communication state that is associated with the contact ID “01aa” of the request sender terminal 10aa, and the communication state that is associated with the contact ID of the destination terminal 10d that the terminal 10aa will call. The manager 53 searches the state change management table of FIG. 8B using the management data “Private Invite”, which is transmitted from the request sender terminal 10aa, and reads pre-change state data and post-change state data for each one of the terminals 10aa and 10d. The manager 53 updates the communication states of the terminals 10, that is, the terminal 10aa and the destination terminal 10d, based on the terminal data, the pre-change state data, and the post-change state data. In this example, the manager 53 changes the communication state of the terminal 10aa, from the pre-change state data “None” to the post-change state data “Private Calling”. Similarly, the manager 53 changes the communication state of the destination terminal 10d, from the pre-change state data “None” to the post-change state data “Private Ringing”. Further, the manager 53 changes, in the terminal management table of FIG. 7B, the operating states that are respectively associated with the contact IDs of the request sender terminal 10aa and the destination terminals 10d, to the operating states “Online (communicating)”.

At S79, the session control 58 of the management system 50 selects one of the relay devices 30, which relays content data between the request sender terminal 10aa and the destination terminal 10d. In the following, it is assumed that the session control 58 selects the relay device 30a.

At S81, the transmitter/receiver 51 transmits relay device connection data to be used for connecting with the relay device 30a, to the request sender terminal 10aa through the communication network 2. The relay device connection data includes the IP address “1.2.1.2” of the relay device 30a, authentication information, and a port number, etc. The transmitter/receiver 51 may further transmit a session ID of a session to be established, which is generated at the management system 50, to the request sender terminal 10aa, for example, as the relay device connection data.

At S82, the transmitter/receiver 51 transmits a request for starting communication to the destination terminal 10d. The communication start request includes the contact ID “01aa” of the request sender terminal 10aa. With the communication start request, the transmitter/receiver 51 transmits the management data “Private Invite” indicating a communication start request with restricted participation from the other terminal, and relay device connection data to be used for connecting with the relay device 30a, to the destination terminal 10d. Further, the IP address of the management system 50 is transmitted to the destination terminal 10d from the management system 50. The destination terminal 10d, which receives the communication start request, transmits the management data “Accept” indicating acceptance of the communication start request, to the request sender terminal 10aa through the management system 50. When the communication start request is accepted, the request sender terminal 10aa and the destination terminal 10d each transmit the management data “Join” indicating a request for starting relay of content data, to the management system 50. When the management system “Join” is received at the transmitter/receiver 51, the session control 58 establishes a content data session “sed” between the request sender terminal 10aa and the counterpart terminal 10d.

Every time the management data is received from the terminal 10, the manager 53 of the management system 50 updates the communication states of the request sender terminal 10aa and the request destination terminal 10d in the terminal management table of FIG. 7B, based on the received management data, in a substantially similar manner as described above referring to S76 of FIG. 11. For example, as illustrated in FIG. 9A or 9B, the manager 53 changes the communication states of the request sender terminal 10aa and the destination terminal 10d, respectively, to “Private Accepted” based on the management data “Accept”, and to “Private Busy” based on the management data “Join”.

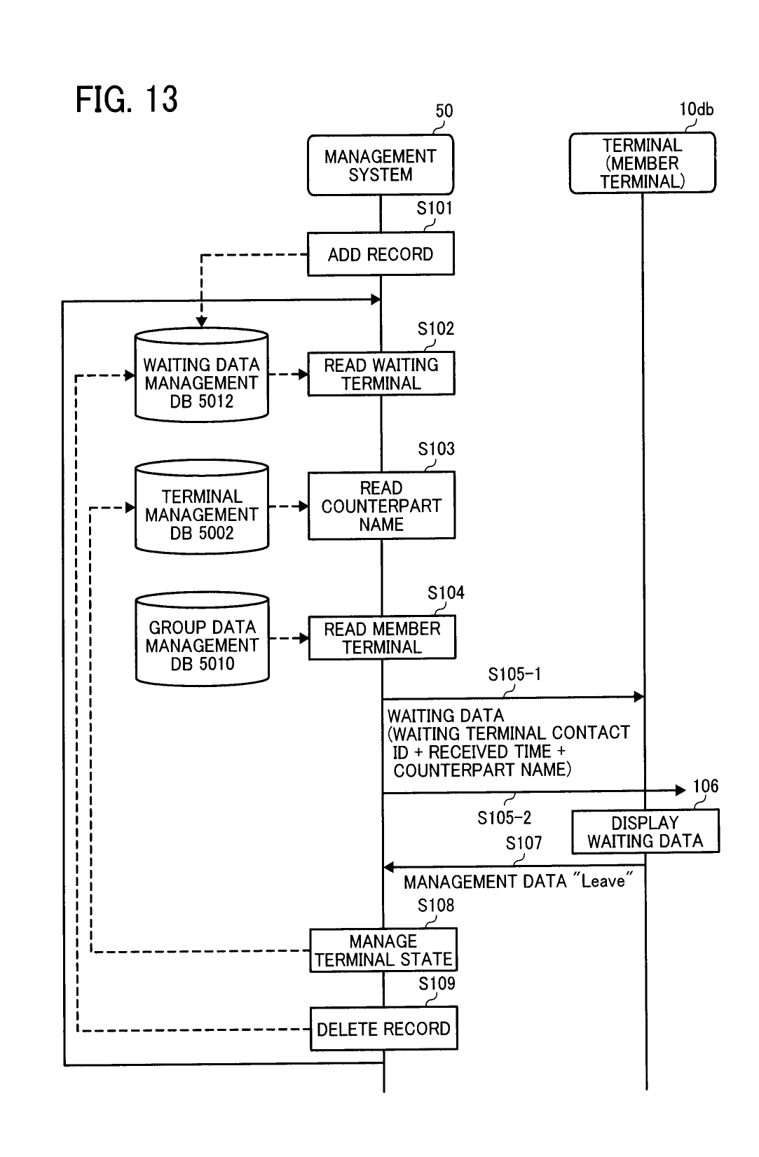

Referring now to FIG. 13, the example case is explained in which the terminals 10d at the call center are all communicating, when the request for starting communication with the call center is transmitted from the terminal 10aa using the reception application 1032. In such case, the terminal 10aa is notified of a message indicating that the terminal 10aa cannot start communication as described below referring to FIG. 13.

Assuming that all of the terminals 10d at the call center are communicating, at S101, the memory control 59 of the management system 50 adds a record to the waiting data management table of FIG. 8D, which includes the group contact ID “01xx” of the group of the terminals 10d, the contact ID “01aa” of the request sender terminal 10aa as the contact ID of the waiting terminal 10, and the date/time at which the management system 50 receives the communication start request.

At S102, the memory control 59 reads out the group contact ID “01xx” of the group of the terminals 10d and the received date/time, from the waiting data management table (FIG. 8D). At S103, the memory control 59 searches the terminal management table (FIG. 7B) using the contact ID of the waiting terminal 10aa from the waiting data management table of FIG. 8D as a search key to obtain the counterpart name (terminal name) associated with the waiting terminal 10aa.

At S104, the memory control 59 searches the group data management table (FIG. 8C) using the group contact ID “01xx” of the terminals 10d as a search key to obtain a contact ID of each one of the terminals 10d belonging to the group having the contact ID “01xx”.

At S105 (S105-1, S105-2, etc.), the transmitter/receiver 51 of the management system 50 transmits waiting data to each one of the terminals 10d having the contact IDs that are read at S104. For example, at S105-1, the transmitter/receiver 51 of the management system 50 transmits waiting data to the terminal 10db having the operating state “Online (Communicating)”. The waiting data in this example includes the contact ID of the waiting terminal 10aa, the received date/time at which the management system 50 receives the communication start request from the terminal 10aa, and the counterpart name of the waiting terminal 10aa obtained at S103. In a substantially similar manner, the waiting data is transmitted to each one of the terminals 10d at the call center.

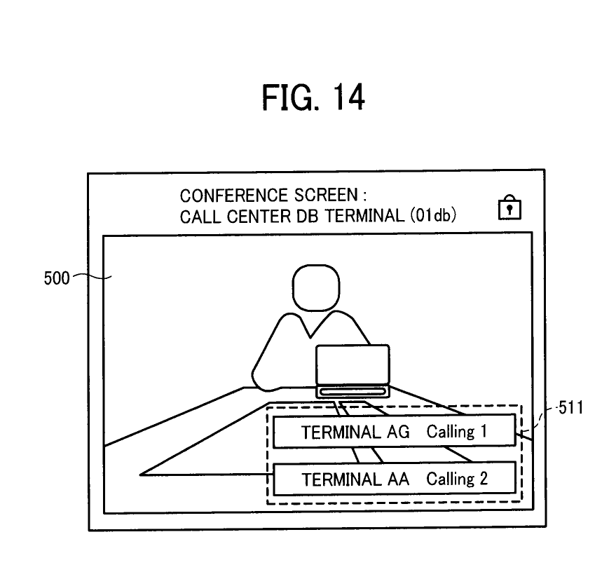

When the waiting data is received at the transmitter/receiver 11 of the terminal 10d, at S106, the display control 24 of the terminal 10d causes the display 120d to display on a conference screen the counterpart name of the waiting terminal 10aa that is included in the waiting data. When there is more than one waiting terminal 10 that is waiting to start communication with the terminal 10d, the conference screen at the terminal 10d lists the counterpart names of the waiting terminals 10 in an order of the received date/time. FIG. 14 illustrates an example conference screen, displayed on the display 120db for the terminal 10db at S106. The display control 24 of the terminal 10db outputs a message 511 that lists one or more waiting terminals 10 based on the waiting data received at the terminal 10db, in addition to an image 500 captured at a counterpart terminal 10 that is currently communicating with the terminal 10db. With this message 511 of FIG. 14, the terminal 10db at the call center is able to obtain information regarding the waiting terminal 10 that is waiting.

Assuming that the terminal 10db ends communication, at S107, the transmitter/receiver 21 of the terminal 10db transmits the management data “Leave” indicating end of communication, to the management system 50. At the management system 50, which receives the management data “Leave”, the session control 58 ends a content data session “sed” between the terminal 10db and the counterpart terminal 10 of the terminal 10db.

At S108, the manager 53 updates the operating state of the terminal 10db in the terminal management table (FIG. 7B), from the “Online (communicating)” to “Online (communication OK)”. The manager 53 further updates the communication state of the terminal 10db in the terminal management table (FIG. 7B), from the state “Private Busy” to “None”. As the operating state is updated to “Online (communication OK)”, the session control 58 of the management system 50 determines the terminal 10db as the destination terminal 10d to be called by the waiting terminal 10aa. The session control 58 of the management system 50 establishes a content data session between the waiting terminal 10aa and the destination terminal 10db that is selected as a counterpart terminal of the waiting terminal 10aa, in a substantially similar manner as described above referring to S76 to S82.

As the content data session “sed” is established between the waiting terminal 10 and the destination terminal 10db, at S109, the memory control 59 deletes, from the waiting data management table (FIG. 8D), a record including the contact ID of the waiting terminal 10aa that has started communication with the terminal 10db.

The management system 50 may periodically repeat S102 to S109. In this manner, the management system 50 is able to notify the updated waiting data, to one or more terminals 10d at the call center.

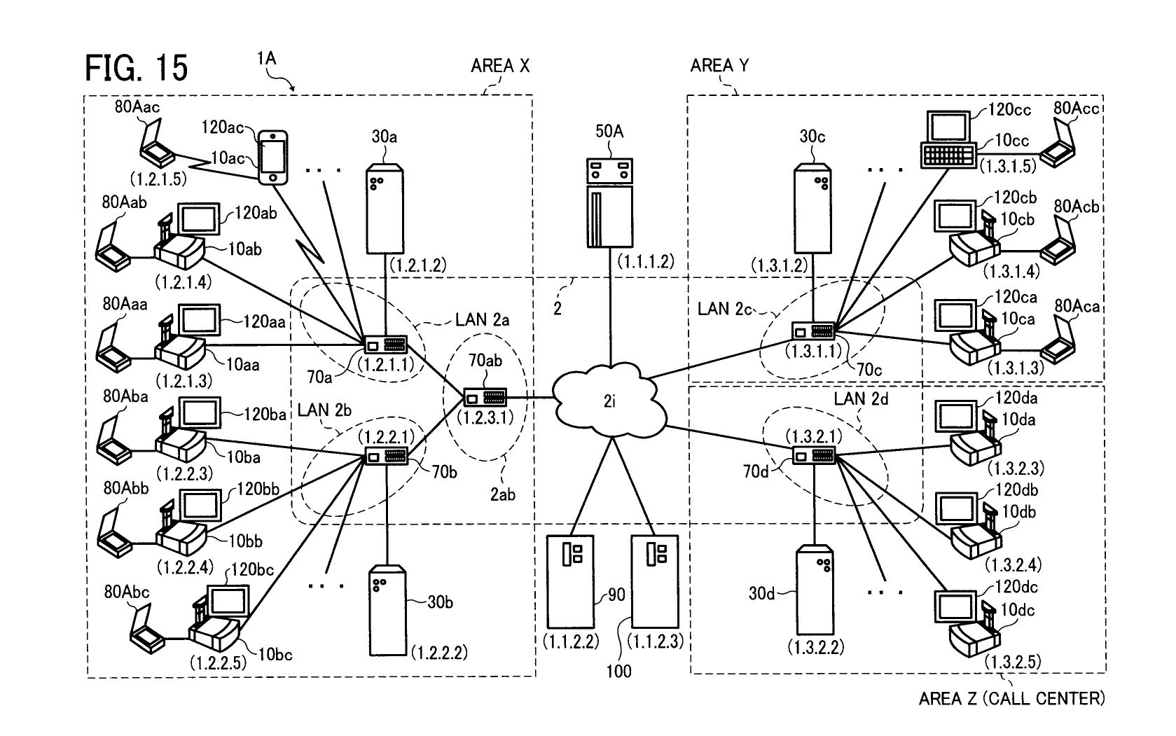

Referring now to FIG. 15, a communication system 1A is explained according to another example embodiment of the present invention. For simplicity, those elements that are different than the above-described embodiment of the communication system 1 of FIG. 1 are specifically described below.

The communication system may be implemented in various other ways, for example, as described below referring to FIGS. 15 to 25. In the following, the terminal 10, which serves as a request sender terminal, may be shared among a plurality of users. In such case, the terminal 10 sends user identification information for identifying a user currently operating the terminal 10 to the management system 50. In the following, the user identification information to be transmitted differs from a contact ID of the terminal 10. For example, the user identification information may be any information that can help to identify the user, such as information obtainable from a business card.

<Configuration of Communication System>

FIG. 15 is a schematic diagram illustrating a configuration of a communication system 1A according to an embodiment of the present invention. As illustrated in FIG. 1, the terminals (10aa, 10ab, . . . , 10ba, 10bb . . . , 10ca, 10cb, . . . ) in the areas X and Y are connected to the image reading devices (80Aaa, 80Aab, . . . , 80Aba, 80Abb, . . . , 80Aca, 80Acb, . . . ), respectively. In the following, any arbitrary image reading device of the plurality of image reading devices (80Aaa, 80Aab, . . . , 80Aba, 80Abb, . . . , 80Aca, 80Acb, . . . ) is referred to as the image reading device 80A.

<Hardware Configuration of Image Reading Device>

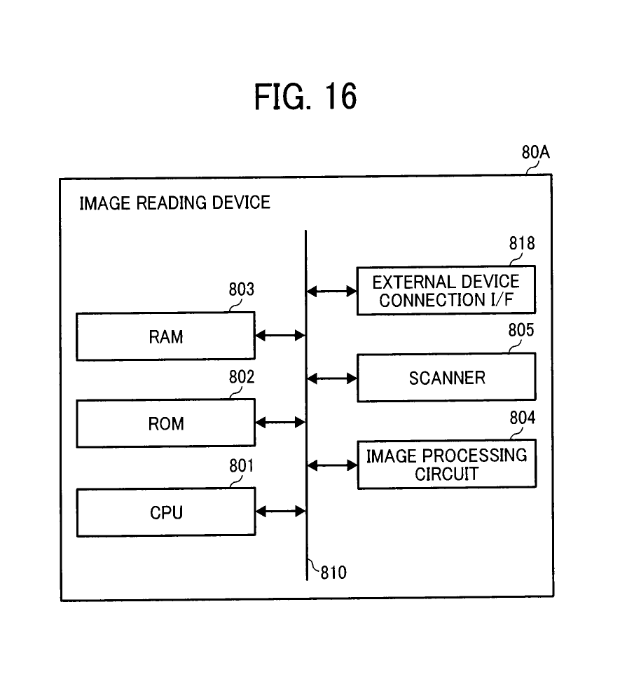

FIG. 16 is a schematic block diagram illustrating a hardware configuration of the image reading device 80A. As illustrated in FIG. 16, the image reading device 80A includes a CPU 801, a ROM 802, a RAM 803, an image processing circuit 804, a scanner 805, a bus line 810, and an external device connection I/F 818.

The CPU 801 is one or more processors capable of controlling entire operation of the image reading device 80A. The ROM 802 stores one or more programs to be used for operating the CPU 801. The RAM 803 functions as a work area for the CPU 101. The image processing circuit 804 applies various processing to image data that is read by the scanner 805. The scanner 805 optically scans a document into image data of the document. More specifically, the scanner 805 irradiates a scanning light to the document surface to receive a reflection light from the document surface, and applies photoelectrical conversion with a photo-electric conversion element such as a charged coupled device (CCD) to the reflection light to obtain the image data of the document. The bus line 810 connects the CPU 801, ROM 802, RAM 803, image processing circuit 804, scanner 805, and external device connection I/F 818, for example, to transfer image data among these elements. The external device connection I/F 818 is an interface that inputs or outputs such as image data from or to the terminal 10, via wired communication (such as cable) or wireless communication.

<Functional Configuration>

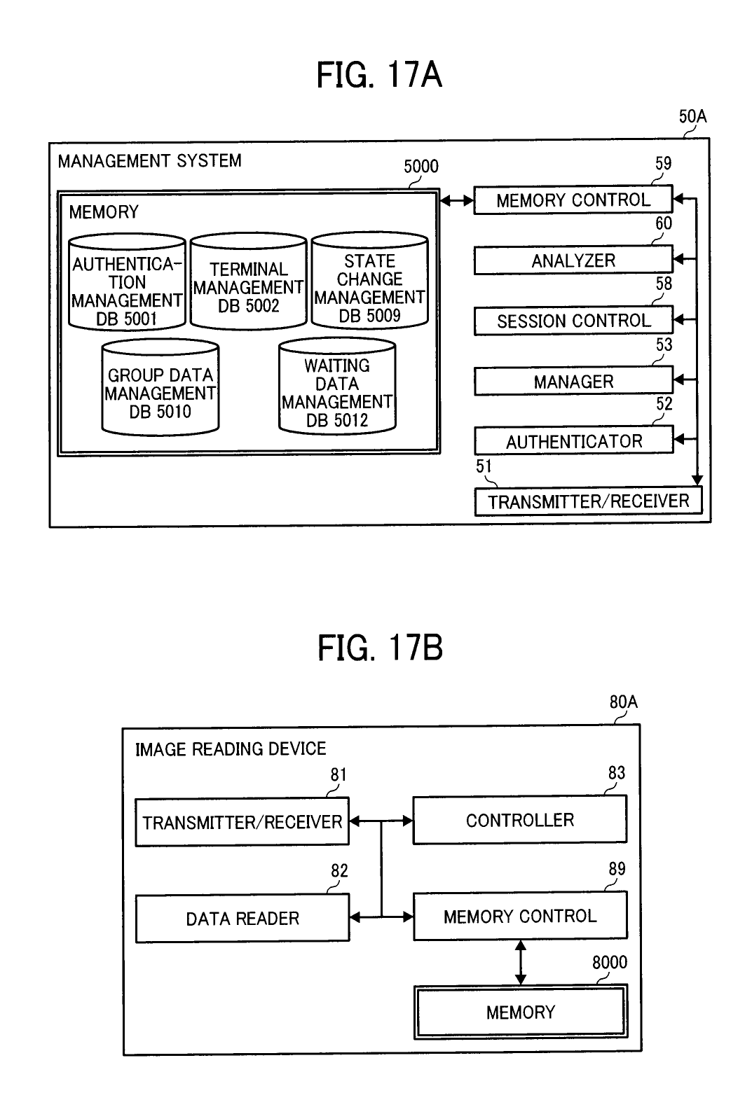

Now, functional configuration of the management system 50A is described. FIG. 17A is a schematic block diagram illustrating functional configuration of the management system 50A of the communication system 1A. In this embodiment, it is assumed that the terminal 10 operating as a request sender terminal that starts communication with the terminal 10d at the call center is located at a receptionist of a company, or any other area that the guest checks in. In the following, the user at the request sender terminal 10 is referred to as a guest.

(Authentication Management Table)

The management system 50A includes the memory 5000, which stores an authentication management DB 5001 implemented by an authentication management table and a guest management table. The authentication management table in this embodiment is substantially similar to the authentication management table of FIG. 7A managed by the management system 50, such that its description is omitted.

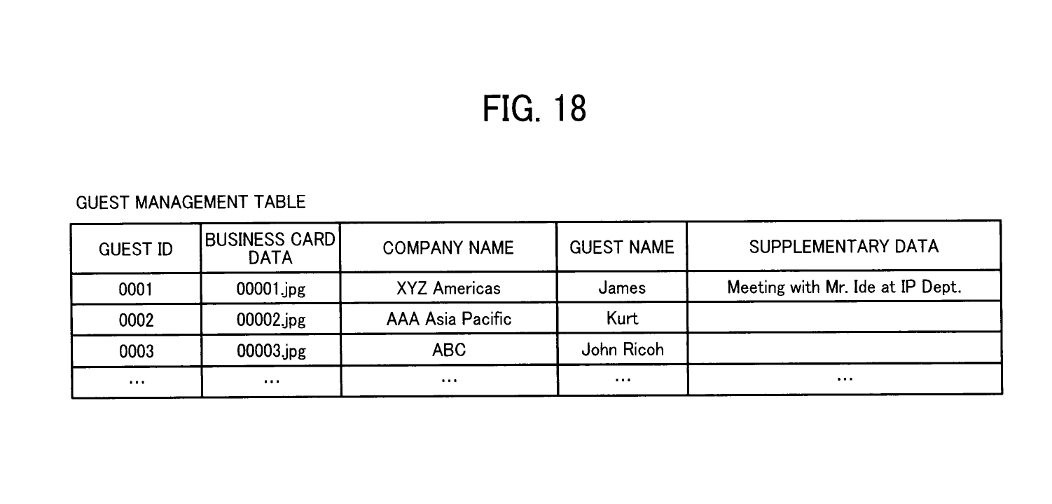

FIG. 18 is a conceptual diagram illustrating the guest management table. The guest management table of FIG. 18 stores, for each one of a plurality of guests, a guest ID, business card data, company name, guest name, and supplementary data, in association with one another. The guest ID is identification information for identifying the guest. The business card data is a file name of image data of a business card of the guest, which is obtained by scanning the business card of the guest. In alternative to the file name, any identification information for identifying the image data of the business card may be used, such as a link to the image data of the business card. The company name is a name of the company to which the guest belongs to, which is read out from the image data of the business card of the guest. The guest name is a name of the guest, which is read out from the image data of the business card of the guest. The supplementary data is any information related to the guest, which may be previously stored.

<Functional Configuration of Management System>

As illustrated in FIG. 17A, the management system 50A differs than the management system 50 in that the management system 50A additionally includes an analyzer 60. The analyzer 60, which is implemented by the instructions of the CPU 201, analyzes the image data of the business card. More specifically, from the image data of the business card, the analyzer 60 extracts the company name and the guest name.

<Functional Configuration of Image Reading Device>

Now, functional configuration of the image reading device 80A is described. FIG. 17B is a schematic block diagram illustrating functional configuration of the image reading device 80A of the communication system 1A. The image reading device 80A includes a transmitter/receiver 81, a data reader 82, a controller 83, and a memory control 89. The image reading device 80A further includes a memory 8000, which may be implemented by the ROM 802 or the RAM 803.

The transmitter/receiver 81, which may be implemented by the instructions of the CPU 801 and the external device connection I/F 818, transmits or receives various data (or information) to or from the terminal 10 through a cable or wireless network.

The image reader 82, which may be implemented by the scanner 805 that operates according to the instructions of the CPU 801, scans the document (business card) placed on an image reading section of the scanner 805 into the image data.

The controller 83, which may be implemented by the CPU 801 and the image processing circuit 804, controls entire operation of the image reading device 80A.

<Operation>

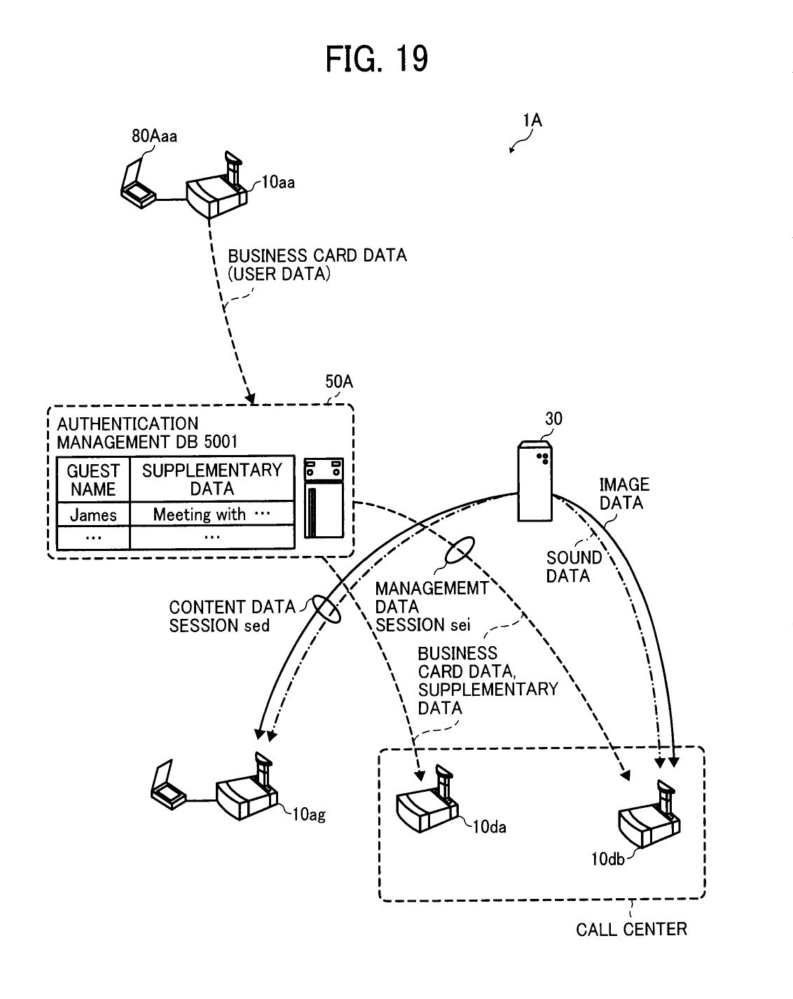

Referring to FIG. 19, operation performed by the communication system 1A is described according to the embodiment of the present invention. FIG. 19 is a conceptual diagram illustrating transmission or reception of content data and various management data in the communication system 1A.

In this example, the terminal 10aa, which requests to start communication, is connected to the image reading device 80Aaa. The image reading device 80Aaa reads the business card of the guest, who is the user at the terminal 10aa, to output the image data of the business card. The output image data of the business card is input to the transmitter/receiver 21 of the terminal 10aa. The transmitter/receiver 21 of the terminal 10aa transmits information regarding the business card (“business card data”), which includes the output image data, to the management system 50A. The management system 50A receives the business card data including the image data of the business card, at the transmitter/receiver 51. The transmitter/receiver 51 of the management system 50A transmits the business card data to the terminal 10d at the call center, before the request sender terminal 10aa connects with the terminal 10d (10da, 10db, . . . ). With this configuration, the terminal 10d at the call center is able to know about the guest based on the business card data, before the guest at the request sender terminal 10aa calls the call center. In this manner, the operator at the call center can be prepared before receiving the call from the guest at the terminal 10aa, for example, by obtaining necessary material or notifying a person in charge of arrival of the guest.

For example, the management system 50A stores, for each one of a plurality of guests previously registered, information regarding the guest such as the name of the guest and supplementary data regarding the guest, in the guest management table of the authentication management DB 5001. The analyzer 60 of the management system 50A analyzes the image data of the business card, to extract the name of the guest. The transmitter/receiver 51 obtains the supplementary data, which is associated with the guest name that is obtained by the analyzer 60, to the terminal 10d at the call center. With this configuration, the operator at the call center is able to know about the guest, before the guest at the terminal 10aa connects with the terminal 10d at the call center to have conversation with the operator.

After the terminal 10aa starts communication with the terminal 10d at the call center, the transmitter/receiver 51 of the management system 50A may further receive supplementary data of the guest, who is the user at the terminal 10aa. When the supplementary data is received, the management system 50 stores in the guest management table of the authentication management DB 5001, the supplementary data received at the transmitter/receiver 51, in association with the name of the guest at the terminal 10aa. With the guest management table, the supplementary data can be managed based on content of communication between the user at the terminal 10aa and the operator at the call center. When the same user calls the call center for the next time, the operator is able to have the supplementary data before the user calls.

All of the terminals 10d at the call center may be communicating with the other terminal 10, when receiving the communication start request from the terminal 10aa. As described above, the operator at the terminal 10d is able to know about the guest at the terminal 10, while communicating with the other terminal. With this information, the operator at the call center is able to determine whether to keep communicating with the other terminal 10, or to interrupt communication currently held to start talking with the user at the terminal 10aa.

The transmitter/receiver 11 of the terminal 10d at the call center receives the business card data transmitted from the management system 50A. The display control 24 of the terminal 10d controls display of image data based on the business card data. The operation input 12 of the terminal 10d receives a selection of a communication destination based on the image data. The transmitter/receiver 11 of the terminal 10d transmits information for identifying the selected counterpart terminal to the management system 50A. With this configuration, the terminal 10d at the call center is able to select a communication destination based on the business card data transmitted from the management system 50A.

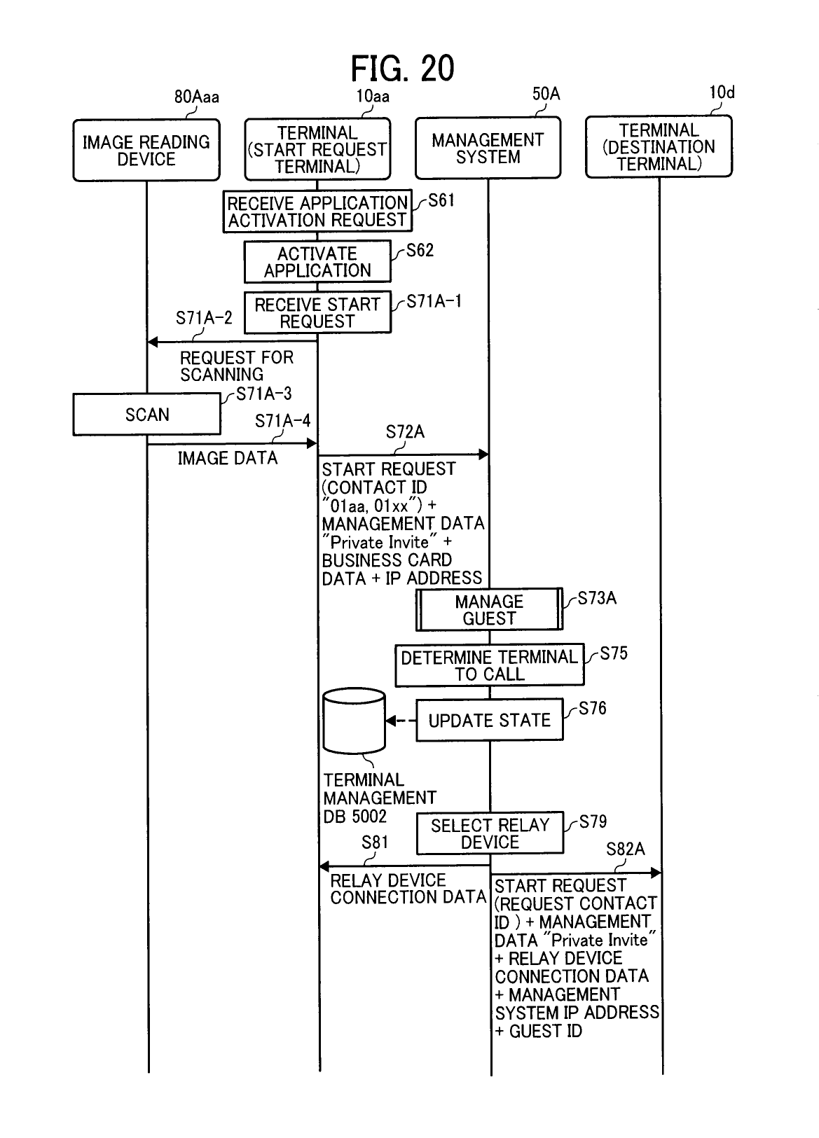

Now, operation performed by the communication system 1A is explained according to an example embodiment of the present invention. Referring to FIG. 20, operation of processing a communication start request by the terminal 10aa, is explained. FIG. 20 is a data sequence diagram illustrating operation of processing a communication start request.

In response to selection of the operation key (108a to 108e) by the user at the terminal 10aa, at S61, the operation input 12 of the terminal 10aa receives an activation request for activating the reception application 1032.

At S62, the operation input 12 of the device controller 1050 instructs the activator 22 to activate the communication controller 1060 under control of the reception application 1032. While the steps before S62 is performed by the device controller 1050, the following steps are performed by the communication controller 1060 under control of the reception application 1032.

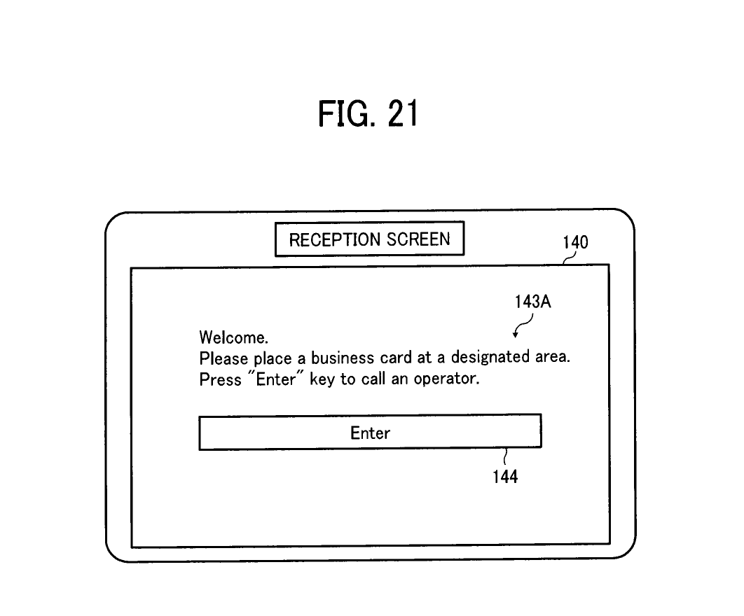

The display control 24 of the communication controller 1060 causes the display 120aa to display a reception screen, which accepts a communication start request for starting communication with the call center. FIG. 21 illustrates an example reception screen. The screen 140 includes a message 143A requesting the guest to place the business card on the image reading section of the image reading device 80A, and a key 144 for accepting the communication start request.

When the user (guest) at the terminal 10aa presses the key 144 on the reception screen 140 after placing the business card, at S71A-1, the function executor 25 accepts a communication start request.

At S71A-2, the transmitter/receiver 21 of the terminal 10aa transmits a request for scanning the business card of the guest into image data, to the image reading device 80Aaa.

When the image reading device 80Aaa receives the scanning request at the transmitter/receiver 81, at S71A-3, the image reading device 82 scans the business card into image data. At S71A-4, the transmitter/receiver 81 of the image reading device 80Aaa transmits the image data of the business card to the terminal 10aa. The terminal 10aa receives the image data at the transmitter/receiver 21.

At S72A, the transmitter/receiver 21 of the terminal 10aa transmits a communication start request to the management system 50A, with the IP address of the terminal 10aa that is the request sender terminal. The communication start request includes the contact ID “01aa” of the request sender terminal 10aa, and the contact ID “01xx” of the counterpart terminal. In addition, the transmitter/receiver 21 transmits the business card data including the image data obtained at S71A-4, and the management data “Private Invite”. In this embodiment, the contact ID “01xx” of the counterpart terminal is a group contact ID of the group of terminals 10d at the call center, which is automatically selected by the transmitter/receiver 21 under control of the reception application 1032. The management data “Private Invite” indicates a communication start request for starting communication while restricting participation from the other terminals, and automatically selected by the transmitter/receiver 21 under control of the reception application 1032.

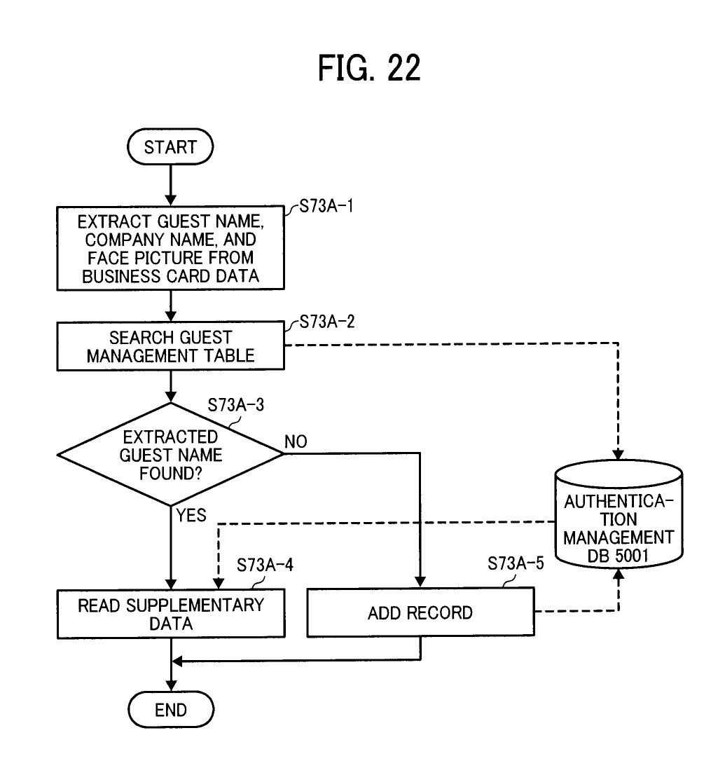

At S73A, the management system 50A, which receives the communication start request, manages information regarding the guest using the business card data transmitted with the communication start request. Referring to FIG. 22, operation performed at S73A is explained. FIG. 22 is a flowchart illustrating operation of managing information regarding the guest.

At S73A-1, the analyzer 60 analyzes the image data of the business card to extract, from the image data, character data such as the name of the guest and the company name printed on the business card, and a picture of face of the guest. Any desired image analyzing method may be used, such as the image analyzing method used for an Optical Character Reader (OCR).

At S73A-2, the memory control 59 searches the guest management table of FIG. 18 in the authentication management DB 5001 using the name of the guest that is extracted as a search key.

At S73A-3, the manager 53 determines whether the name of the guest that is extracted from the image data of the business card matches any one of guest names in the guest management table (FIG. 18), based on search at S73A-2. When it is determined that the name of the guest matches at S73A-3, at S73A-4, the memory control 59 searches the guest management table (FIG. 18) using the name of the guest that is extracted from the image data of the business card as a search key to obtain the supplementary data associated with the name of the guest.

When it is determined that the name of the guest does not match any guest name in the guest management table (FIG. 18) at S73A-3, the manager 53 generates a guest ID for identifying the guest.

At S73A-5, the memory control 59 adds a record to the guest management table (FIG. 18), which includes the guest ID that is generated, a file name of the image data of the business card, the company name, and the guest name, in association with one another. As the image data of the business card, a file name of a picture extracted from the business card (such as the face of the guest) may be stored. The operation ends to proceed to S75 of FIGS. 20.

At S75 to S82A, the management system 50 establishes a content data session between the request sender terminal 10aa and the destination terminal 10d, which is determined to be a destination terminal at the call center, in a substantially similar manner as described above referring to S75 to S82 of FIG. 11.

However, at S82A, the management system 50 transmits the communication start request to the destination terminal 10d but with additional data that is the guest ID of the guest at the terminal 10aa. The guest ID is obtained from the guest management table using the name of the guest read from the image data of the business card, or may be newly generated, as described above. This guest ID is used by the terminal 10d at the call center to transmit supplementary data of the guest to the management system 50A.

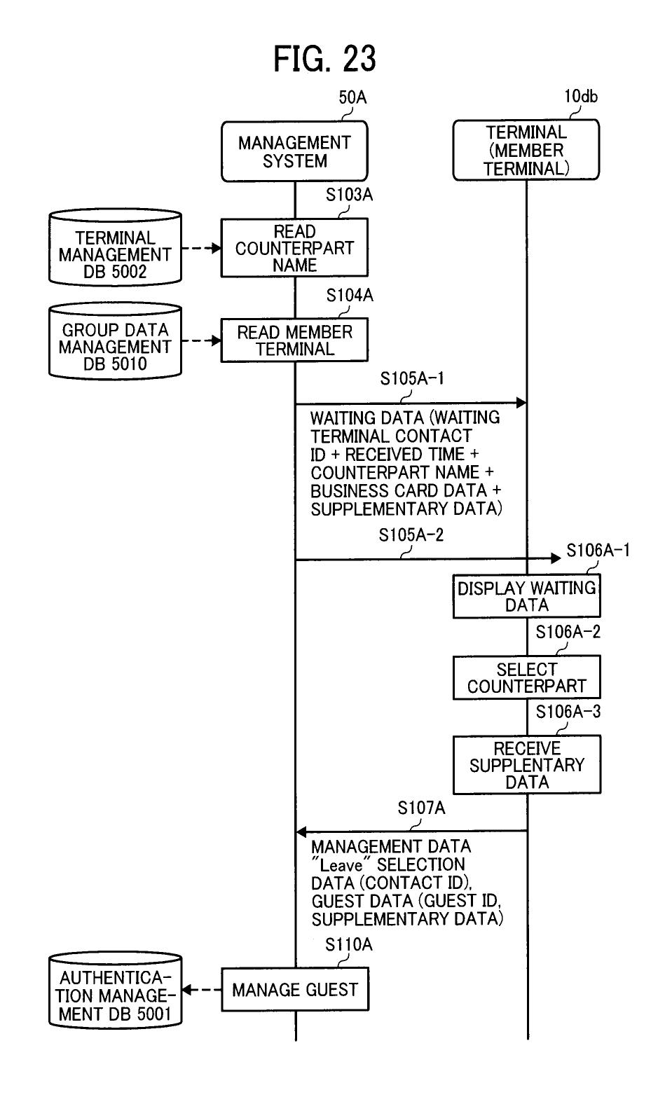

Referring now to FIG. 23, the example case is explained in which the terminals 10d at the call center are all communicating, when the request for starting communication with the call center is transmitted from the terminal 10aa using the reception application 1032. In such case, the terminal 10aa is notified of a message indicating that the terminal 10aa cannot start communication as described below referring to FIG. 23.

Assuming that all of the terminals 10d at the call center are communicating, at S103A, the memory control 59 of the management system 50A searches the terminal management table (FIG. 7B) using the contact ID of the waiting terminal 10aa as a search key to obtain the counterpart name (terminal name) associated with the waiting terminal 10aa.

At S104A, the memory control 59 searches the group data management table (FIG. 8C) using the group contact ID “01xx” as a search key to obtain a contact ID of each one of the terminals 10d belonging to the group having the contact ID “01xx”.

At S105A (S105A-1, S105A-2, etc.), the transmitter/receiver 51 of the management system 50 transmits waiting data to each one of the terminals 10d having the contact IDs that are read at S104A. For example, at S105A-1, the transmitter/receiver 51 of the management system 50 transmits waiting data to the terminal 10db having the operating state “Online (Communicating)”. The waiting data in this example includes the contact ID of the waiting terminal 10aa, the received date/time at which the management system 50 receives the communication start request from the terminal 10aa, the counterpart name of the waiting terminal 10aa obtained at S103A, the business card data received at S72A, and the supplementary data obtained at S73A-4 if such data is available. The business card data transmitted at S105A-1 may be business card data transmitted from the terminal 10aa at S72A such as the image data of the business card, or may be any information extracted from the image data of the business card by the analyzer 60 at S73A. Such extracted information includes, for example, characters such as the name of the guest and a company name of the guest printed on the business card, and an image of a face of the guest.

In the following, the case in which the terminal 10db receives the waiting data is described as an example.

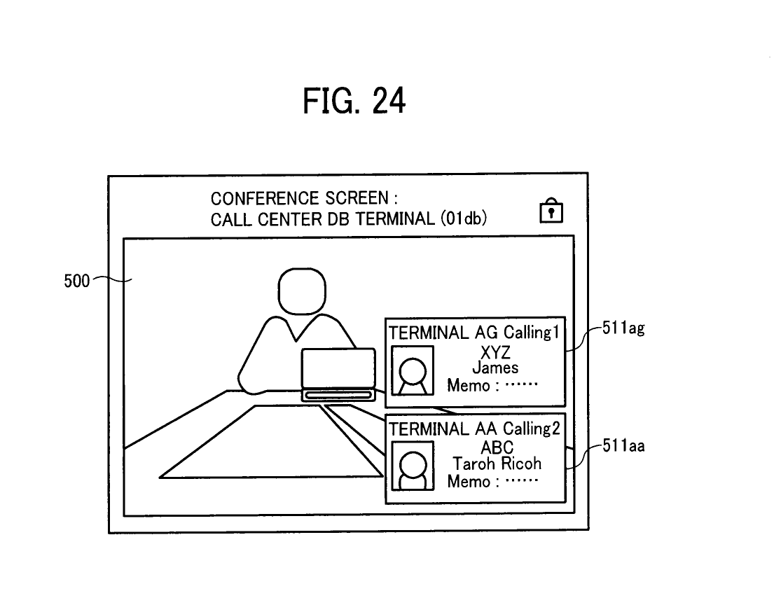

When the terminal 10db at the call center receives the waiting data at the transmitter/receiver 11, at S106A-1, the display control 24 causes the display 120db to display a conference screen including the counterpart name of the waiting terminal 10aa, and any information obtained from the business card data, which is included in the waiting data. When there is more than one waiting terminal 10 that is waiting to start communication with the terminal 10db, the conference screen at the terminal 10db lists the counterpart names of the waiting terminals 10 in an order of the received date/time. FIG. 24 illustrates an example conference screen, displayed on the display 120db for the terminal 10db at S106A-1. The display control 24 of the terminal 10db outputs one or more messages that are respectively generated for one or more waiting terminals 10 based on the waiting data, along with an image 500 captured at a counterpart terminal 10 that is currently communicating with the terminal 10db. In this example, the message 511ag is generated based on the waiting data of the terminal 10ag, and the message 511aa is generated based on the waiting data of the terminal 10aa. The message generated based on the waiting data includes information obtained from the business card data such as the guest name, and supplementary data associated with the guest name (shown as memo). With this information, the terminal 10d at the call center is able to know that there is one or more guests (users) who are waiting, and any information that can be obtained from the business card of the guest or associated with the guest in the guest management table.

Assuming that the terminal 10db ends a session with the counterpart terminal, and starts communication with the terminal 10aa, the operator at the terminal 10db selects the message 511a on the display 120db that corresponds to the terminal 10aa. At S106A-2, the operation input 12 of the terminal 10db receives user selection that selects the terminal 10aa as a communication destination. The operator, who is the user at the terminal 10db, may select the waiting terminal 10 that has been waiting for the longest time (with the earliest received date/time), or may select the waiting terminal 10 based on determination of whether the operator is able to help the guest at the waiting terminal 10 referring to the memo.

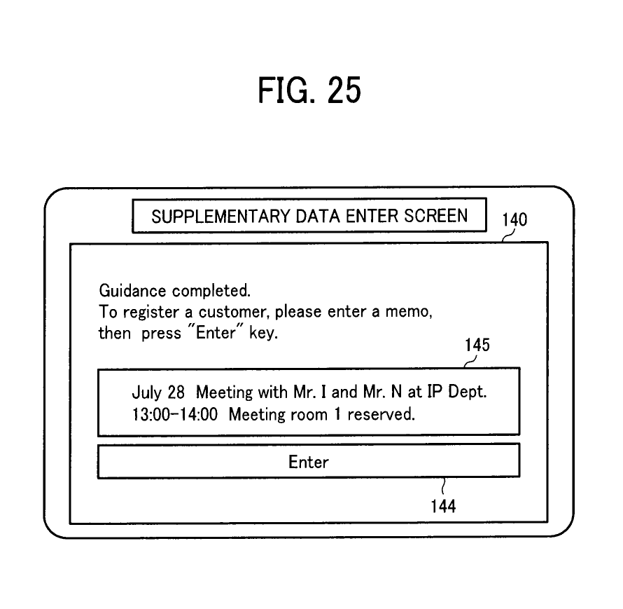

At S106A-3, the display control 24 of the terminal 10db causes the display 120db to display a screen, which requests the operator to enter additional information regarding the guest (who is currently having communication) as supplementary data. FIG. 25 is an example supplementary data enter screen. For example, when the terminal 10db operates with a reservation system, the operator may reserve a meeting room to be used by the guest for the next visit, and enter reservation information such as the reserved room in an input field 145. With this supplementary data, for the next time that the guest visits, any operator at the call center is able to smoothly guide the guest to the reserved room. After entering all necessary information, the operator at the terminal 10db presses an “Enter” key 144 on the window 140. In response to selection of the “Enter” key 144, the operation input 12 receives entered information as supplementary data.

At S107A, the transmitter/receiver 21 of the terminal 10db transmits the management data “Leave” indicating end of communication, and selection of a destination communication that is the contact ID “01aa” of the terminal 10aa, to the management system 50. More specifically, the transmitter/receiver 21 of the terminal 10db transmits additional supplementary data of the guest, which is entered at S106A-3, and the guest ID of the guest that is received at S82A, to the management system 50A.

The management system 50, which receives the management data “Leave”, causes the session control 58 to end a content data session “sed” between the terminal 10db and the counterpart terminal 10 that is currently communicating. The manager 53 updates the operating state of the terminal 10db in the terminal management table (FIG. 7B), from the “Online (Communicating)” to “Online (Communication OK)”. Similarly, the manager 53 further updates the communication state of the terminal 10db in the terminal management table (FIG. 7B) from “Private Busy” to “None”, as described above referring to FIG. 9B. With this update of the state of the terminal 10db, the terminal 10db becomes a destination terminal that the waiting terminal 10aa will call.

At S75, the session control 58 of the management system 50A determines the terminal 10db as a destination terminal 10 that the waiting terminal 10aa starts communicating.

As described above referring to S76 to S82A, the session control 58 of the management system 50A establishes a content data session “sed” between the terminal 10aa and the destination terminal 10db at the call center. The transmitter/receiver 51 of the management system 50 may transmit the selection data, which is obtained at S107A, to each one of the terminals 10d at the call center that are read at S104A. Based on the selection data, each terminal 10d at the call center is able to delete the message corresponding to the terminal 10aa, from the conference screen.

At S110A, the memory control 59 refers to the guest management table (FIG. 18) in the authentication management DB 5001, and adds the additional supplementary data to the “supplementary data field” in the record for that guest that the operator is currently having communication. With this additional supplementary data, for the next time that the guest calls the operator at the call center, such information is displayed to the operator at the call center.

As described above, even when the request sender terminal 10 is shared among a plurality of users, or even when one account (such as a guest account) is shared among a plurality of users, user information specific to the user who is currently operating the request sender terminal 10 can be transmitted to a counterpart terminal 10 (such as at a call center) that the request sender terminal 10 requests to start communication, before the counterpart terminal 10 starts communicating with the request sender terminal 10. More specifically, the communication management system 50 operates as an information transmission system that transmits user information to the counterpart terminal.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

The relay devices 30, the management system 50, the program providing system 90, and the maintenance system 100 in the above-described embodiment may be configured by a single computer or a plurality of computers to which divided portions (functions) are arbitrarily allocated. In the case where the program providing system 90 is configured by a single computer, a program transmitted by the program providing system 90 may be separately transmitted in units of a plurality of modules, or may be transmitted in its entirety. Further, in the case where the program providing system 90 is configured by a plurality of computers, a program may be divided into a plurality of modules, and the modules may be individually transmitted from the respective computers.

In addition, a recording medium such as a CD-ROM storing the terminal control program, the relay device control program, or the transmission management program in the above-described embodiment, the HD 204 storing these programs (separately or entirety), and the program providing system 90 including the HD 204 are used as program products in the case of providing the terminal program, the relay device program, and the transmission management program to users within a certain country or outside that country.

In the above-described embodiment, the terminal management table of FIG. 7B stores the terminal IP address, as terminal identification information. Alternatively, the fully qualified domain name (FQDN) of each terminal 10 may be managed as long as an FQDN serves as terminal identification information for identifying each terminal 10 on the communication network 2. In this case, an IP address corresponding to an FQDN is obtained by a Domain Name System (DNS) server.

In the above-described embodiment, a videoconference system is used as an example of the communication system 1. Alternatively, the communication system may be a car navigation system. In such case, the terminal 10 at one end may correspond to a car navigation system mounted on one automobile, and the terminal 10 at the other end may correspond to a management terminal or a management server at the management center for managing the car navigation system, or a car navigation system mounted on the other automobile.

The other examples of the communication system 1 include a teleconference system, a personal computer image sharing system, a telephone system including the Internet Protocol (IP) phone, Internet phone, or mobile phone. In the telephone system, the telephone operates as the communication terminal 10.

In addition, although image data and sound data are described as examples of content data in the above-described embodiment, the content data is not limited to these items of data, and the content data may be touch data. In this case, a feeling obtained by a user's contact at one terminal side is transmitted to the other terminal side. Further, the content data may be smell data. In this case, a smell at one terminal side is transmitted to the other terminal side. In addition, the content data may be at least one of image data, sound data, touch data, and smell data. More specifically, when the communication system 1 is used as a remote medical diagnosis system, the content data may be sound data that reflects pulse or beat generated within a human body, image data of electrocardiogram, coordinate data that shows a trend in body temperature, or any other data that may be used to examine the patient.

In addition, although the case in which a videoconference is held by the communication system 1 has been described in the above-described embodiment, the embodiment is not limited to this case. The communication system 1 may be used in meetings, general conversation between family members or friends, or one-way presentation of information.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

1. An information transmission system, comprising:
a receiver that receives, from a first communication terminal that requests for starting communication, user identification information for identifying a first user who is currently operating the first communication terminal; and
a transmitter that transmits the user identification information of the first user to a second communication terminal, before establishing a session between the first communication terminal and the second communication terminal to start communication between the first communication terminal and the second communication terminal.

2. The information transmission system of claim 1, further comprising:
a memory that stores, for each one of a plurality of users who has operated the first communication terminal, user identification information for identifying the user in association with information relating to the user; and
processing circuitry that obtains information relating to the first user that is associated with the user identification information of the first user from the memory, and transmits the obtained information relating to the first user to the second communication terminal.

3. The information transmission system of claim 2, wherein
the receiver further receives additional information relating to the first user, while the first communication terminal is communicating with the second communication terminal through the established session, and
the memory further stores the received additional information relating to the first user in association with the user identification information of the first user.

4. The information transmission system of claim 1, wherein
the processing circuitry further determines whether the second communication terminal is currently communicating with a third communication terminal different than the first communication terminal, and
the transmitter further transmits notification to the second communication terminal, which notifies that the first user is waiting to start communication with the second communication terminal, when the second communication terminal is currently communicating with the third communication terminal.

5. The information transmission system of claim 1, wherein the second communication terminal is an arbitrary one of a plurality of communication terminals belonging to the same group,
the processing circuitry further selects one of the plurality of communication terminals belonging to the same group, which is currently available for communication, as the second communication terminal.

6. A communication system, further comprising:
a first communication terminal that obtains user identification information for identifying a first user who is currently operating the first communication terminal, from a printed document provided by the first user; and
an information transmission system connected to the first communication terminal through a network, including:
a receiver that receives, from the first communication terminal, a communication start request with the user identification information of the first user; and
a transmitter that transmits the user identification information of the first user to a second communication terminal, before establishing a session between the first communication terminal and the second communication terminal to start communication between the first communication terminal and the second communication terminal.

7. The communication system of claim 6, wherein the second communication terminal is an arbitrary one of a plurality of communication terminals belonging to the same group, and
the first communication terminal includes a transmitter that automatically transmits, to the information transmission system, identification information for identifying the group of the plurality of communication terminals with the communication start request.

8. The communication system of claim 6, further comprising:
a display provided for the second communication terminal and configured to display a screen including the user identification information of the first user, before the second communication terminal starts communicating with the first communication terminal.

9. A method of transmitting information, comprising:
receiving, from a first communication terminal that requests for starting communication, user identification information for identifying a first user who is currently operating the first communication terminal; and
transmitting the user identification information of the first user to a second communication terminal, before establishing a session between the first communication terminal and the second communication terminal to start communication between the first communication terminal and the second communication terminal.

10. The method of claim 9, further comprising:
storing in a memory, for each one of a plurality of users who has operated the first communication terminal, user identification information for identifying the user in association with information relating to the user;
obtaining information relating to the first user that is associated with the user identification information of the first user from the memory; and
transmitting the obtained information relating to the first user to the second communication terminal.

11. The method of claim 10, further comprising:
receiving additional information relating to the first user, while the first communication terminal is communicating with the second communication terminal through the established session; and
storing the received additional information relating to the first user in association with the user identification information of the first user.

12. The method of claim 9, further comprising:
determining whether the second communication terminal is currently communicating with a third communication terminal different than the first communication terminal; and
transmitting notification to the second communication terminal, which notifies that the first user is waiting to start communication with the second communication terminal, when the determining determines that the second communication terminal is currently communicating with the third communication terminal.

13. The method of claim 9, wherein the second communication terminal is an arbitrary one of a plurality of communication terminals belonging to the same group, the method further comprising:
selecting one of the plurality of communication terminals belonging to the same group, which is currently available for communication, as the second communication terminal.
